(19) United States
(12) Patent Application Publication
(10) Pub. No.: US 2026/0208069 A1
(43) Pub. Date: Jul. 23, 2026

(54) METHOD AND APPARATUS FOR AUTOMATED AND CONTINUOUS EXTRACTION OF BIOMASS

(71) Applicant: Unified Science LLC, Center City, MN (US)

(72) Inventor: Jonathan D. Thompson, Center City, MN (US)

(21) Appl. No.: 19/142,198

(22) PCT Filed: Dec. 22, 2023
(86) PCT No.: PCT/IB2023/063186

§ 371 Date: Jun. 21, 2025

Related U.S. Application Data
(60) Provisional application No. 63/434,757, filed on Dec. 22, 2022.
(60) Provisional application No. 63/437,032, filed on Jan. 4, 2023.
(60) Provisional application No. 63/437,207, filed on Jan. 5, 2023.
(60) Provisional application No. 63/478,953, filed on Jan. 8, 2023.

(51) Int. Cl. B01D 11/02; B01D 1/28; B01D 3/10

(52) U.S. Cl. CPC B01D 11/0296; B01D 1/2896; B01D 3/10; B01D 11/0203; B01D 11/0207; B01D 11/0284; B01D 11/0288

(57) ABSTRACT

A method of converting a botanical-based biomass to an extract in a continuous process includes contacting the biomass with an extracting fluid to obtain an extraction product including an extracted oil, conditioning the extraction product in an interface chamber by maintaining the extracted oil in a flowable condition and releasing one or more gasses through a unidirectional vent, and transferring the conditioned extraction product directly to a purification system.

### BACKGROUND

Many traditional processes utilize discontinuous or batch processes to produce a product. These discontinuous processes suffer from inefficient quality control and the product is at risk for external contamination. In particular, typical botanical extraction techniques utilize a batch process to obtain purified extracts. These techniques require a large number of steps and are at risk for airborne contamination. Further, the systems in a batch process are not typically connected due to the lack of interoperability due to the presence of solvents and the chemical makeup, pressure differentials, and temperature differentials in the overall process. Therefore, it is beneficial to provide a continuous, contained process for botanical extraction while decreasing the total processing steps. This continuous process provides a novel way to control and condition the material throughout each section of the process while a consistent targeted potency is achieved using the non-active plant matrix as the diluent.

### SUMMARY

According to one aspect, a method of converting a botanical-based biomass to an extract in a continuous process includes contacting the biomass with an extracting fluid to obtain an extraction product including an extracted oil, conditioning the extraction product in an interface chamber by maintaining the extracted oil in a flowable condition and releasing one or more gasses through a unidirectional vent, and transferring the conditioned extraction product directly to a purification system.

According to another aspect, a method of converting a botanical-based biomass to an extract in a continuous process includes contacting the biomass with carbon dioxide at a pressure greater than 500 psi to obtain an extraction product including an extracted oil, conditioning the extraction product in an interface chamber by maintaining the extracted oil in a flowable condition and releasing one or more gasses through a unidirectional vent, transferring the conditioned extraction product directly to a winterization system, and winterizing the conditioned extracted oil by contacting the conditioned extracted oil with ethanol, wherein the interface chamber is maintained at a pressure of less than 100 psi.

According to another aspect, an apparatus for recovering an extract from a botanical sample includes an extraction system for contacting the botanical sample with an extraction fluid to obtain an extraction product, an interface system fluidically connected to an outlet of the extraction system, the interface system including a vessel having a vessel chamber with a unidirectional vent, a heat applicator for heating the vessel chamber, and a pump for motivating the extraction product through the vessel, and a control system for operating at least the interface system to condition the extraction product, wherein the control system includes a first sensor for detecting a temperature in the vessel chamber, and being programmed to modulate at least one of the heat applicator and the pump in response to a signal from the first sensor to maintain the extraction product in a flowable condition as it is pumped through the vessel chamber.

According to another aspect, a method for conditioning a biomass-based extract includes receiving into a vessel chamber an unconditioned extraction product, including an extracted oil, obtained from contacting a biomass with a solvent, and conditioning the unconditioned extraction product to a conditioned extraction product by: maintaining the extracted oil in a flowable condition and releasing one or more gasses through a unidirectional vent and maintaining the vessel chamber at an elevated temperature of at least 40° C.

According to another aspect, a method of purifying a botanical-based extract includes obtaining an extraction product by contacting a botanical sample with carbon dioxide, transferring the extraction product directly from an input reservoir to a first stage, purifying the extraction product to a first product and a second product with the first stage defining a first environment having a first pressure and a first set of temperatures, transferring the second product to a second stage, and purifying the second product to a third product and a fourth product with the second stage defining a second environment having a second pressure and a second set of temperatures, wherein the first pressure is different than the second pressure, and wherein each of the first and second products include a target fraction, wherein the temperature and pressure conditions in the first and second stage are adjusted independently of one another to obtain a targeted first and third product potency that may be substantially similar to one another, or adjusted to obtain a fixed ratio of the targeted first and third product potency.

According to another aspect, a method of purifying, a botanical paste extract includes obtaining an extraction product by contacting a botanical sample with carbon dioxide, transferring the Extraction product, directly from an input reservoir to a first stage, purifying the Extraction product to a first product and a second product with the first stage to finding a first environment having a first pressure in the first set of temperatures, transferring the second product for a second stage, and purifying the second product to a third and fourth product with a second stage having a second environment having a second pressure in the second set of temperatures, such that the two environments are adjusted independently of one another, according to an algorithm to obtain target product potencies from the first, second, third, or fourth fractions.

According to another aspect, the first, second third or fourth fractions are subsequently conveyed to additional downstream purification apparatus including chromatography or crystallization units. The conveyance may be obtained using one or more interface devices that are designed to store the fractions, and provide a means to control the mass flow between upstream and downstream purification apparatus.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a method 100 of converting a botanical-based biomass to an extract in a continuous process, according to some embodiments.

FIG. 2 illustrates a method 200 of converting a botanical-based biomass to an extract in a continuous process, according to some embodiments.

FIG. 3A illustrates a process flow diagram 300 for botanical extraction, according to some embodiments.

FIG. 3B illustrates a process flow diagram 350 for botanical extraction, according to some embodiments.

FIG. 4A illustrates a process flow diagram 400 for botanical extraction, according to some embodiments.

FIG. 4B illustrates a process flow diagram 425 for botanical extraction, according to some embodiments.

FIG. 4C illustrates a process flow diagram 450 for botanical extraction, according to some embodiments.

FIG. 4D illustrates a process flow diagram 475 for botanical extraction, according to some embodiments.

FIG. 5A illustrates an extraction to distillation process 500, according to some embodiments.

FIG. 5B illustrates an extraction to distillation process 520, with optional downstream processes, according to some embodiments.

FIG. 5C illustrates a schematic of winterization system 508, according to some embodiments.

FIG. 5D illustrates a schematic of crystallization system 510, according to some embodiments.

FIG. 6 illustrates an extraction system 600, according to some embodiments.

FIG. 7 illustrates a method 700 for conditioning a biomass-based extract, according to some embodiments.

FIG. 8A illustrates an interface system 800, according to some embodiments.

FIG. 8B illustrates an example of vent 814, according to some embodiments.

FIG. 9 illustrates a method 900 of purifying a botanical-based extract, according to some embodiments.

FIG. 10 illustrates a distillation system 1000, according to some embodiments.

FIG. 11A illustrates an extraction to distillation control scheme 1100, according to some embodiments.

FIG. 11B illustrates a distillation control scheme 1160, according to some embodiments.

FIG. 12 illustrates an extraction to interface system control scheme, according to some embodiments.

FIG. 13A illustrates a schematic of a bubble sensor system for distillation system 1000, according to some embodiments.

FIG. 13B illustrates calibration of the bubble sensor system for distillation system 1000, according to some embodiments.

FIG. 14 illustrates a graph comparing the feed pump flow rate to the cannabinoid % of distillate for the distillation system 1000, according to some embodiments.

FIG. 15 illustrates a graph for managing the distillation inlet flow rate based on the average outlet mass flow rate of the extractor, according to some embodiments.

FIG. 16 illustrates a comparison of CBD potency based on various methods, according to some embodiments.

### DETAILED DESCRIPTION

### Definitions

As used herein, the term “biomass” refers to organic material from plants.

As used herein, the term “cannabinoid” refers to one or more compounds found in a cannabis plant. Examples of a cannabinoid include cannabidiol (CBD) and tetrahydrocannabinol (THC).

As used herein, the term “chromatography” refers to a purification stage in a biomass extraction process. For example, chromatography may be utilized to purify and/or separate one or more cannabinoids. In one example, a chromatography stage may include one or more columns sufficient to separate one or more compounds from CBD and purify the cannabidiol. In another example, chromatography may be utilized for separation of minor cannabinoids, separation of nutraceutical or pharmaceutical active ingredients from an extraction product, THC remediation, and THC isolation.

As used herein, the term “condensable fluid” refers to a solid, liquid, or gas that is capable of being condensed at a certain temperature and pressure. For example, a condensable fluid may be in liquid phase and subsequently converted to a gas phase for a condensation process. Examples of condensable fluids include water vapor and liquid water.

As used herein, the term “conditioning” refers to maintaining an extraction product in a state sufficient for downstream process utilization. For example, conditioning may include removing one or more components from an extraction product, preventing oxidation of the extraction product, preventing condensation, maintaining a fluid in a flowable state, directing fluids in or out of a process, and maintaining a desired temperature and pressure setpoint. For example, conditioning may include utilizing a heating component and/or a sweep fluid.

As used herein, the term “conversion” refers to a purification step in a biomass extraction process. For example, an extraction product may be dissolved in a solvent and a reaction may be catalyzed by an acid. The acid may be neutralized, and the solvent may be removed to purify the extraction product. Additionally, conversion may refer to short path distillation to purify an extract.

As used herein, the term “crystallization” refers to a purification stage in a biomass extraction process. A crystallization system may include one or more reactors for purifying and/or crystallizing a compound. In one example, a crystallization system is utilized to produce purified CBD by removing one or more compounds. In another example, a crystallization system includes using a nonpolar solvent to precipitate one or more compounds.

As used herein, the term “distillation” refers to a purification stage in a biomass extraction process. Distillation may be utilized to separate high boiling point components of a mixture from low boiling point components of the same mixture. For example, distillation may include one or more evaporators and condensers. Distillation may separate the extraction product, such as crude oil, into a distillate and a residue. Examples of units within a distillation system include wiped film columns, falling film units, and short path distillation units.

As used herein, the term “extracting fluid” refers to a liquid or gas compound used to remove and/or separate one or more components from another. For example, an extracting fluid may include a liquid solvent and a gas solvent.

As used herein, the term “extraction” refers to a separation process involving solids, liquids, and/or gasses and separating a target compound. For example, extraction may refer to a process of utilizing a liquid or gas solvent to separate a desired component from a solid. The solvent may be utilized for diffusion of molecules and for solubilizing soluble compounds. Extraction may utilize high temperatures and pressures to efficiently extract one or more compounds.

As used herein, the term “flowable” refers to a fluid that is movable and capable of moving in reaction to one or more of gravity and pumping. For example, flowable may refer to a fluid capable of moving through a vessel or pipe. Flowable may refer to a fluid capable of being pumped without causing pump cavitation. In one example, flowable may refer to a lower viscosity liquid in a molten state.

As used herein, the term “isolate” refers to a pure or substantially pure compound produced from biomass extraction and purification. In one example, an isolate may be in the form of a liquid, crystal, and powder. One example of an isolate is cannabidiol powder that is not a full-spectrum powder.

As used herein, the term “residue” refers to one or more compounds separated in a distillation system. For example, a distillation system may separate compounds into a distillate and a residue.

As used herein, the term “supercritical fluid” refers to a fluid with properties of a gas and a liquid. An example of a useful supercritical fluid is carbon dioxide. For example, the critical temperature and pressure of carbon dioxide are about 31° C. and about 1070 psi, respectively.

As used herein, the term “sweep fluid” refers to a liquid or gas utilized for conditioning an extraction product.

As used herein, the term “sweep path” refers to a path, space, or direction for the sweep fluid to flow and/or occupy. For example, a sweep path may include space in a vessel for a gas to flow and occupy above a liquid.

As used herein, the term “target fraction” refers to the amount of a desired component in a product.

As used herein, the term “terpene” refers to a naturally occurring compound in a plant. For example, a terpene may include a monoterpene and a diterpene. In one example, a terpene includes humulene and limonene.

As used herein, the term “winterize” refers to contacting, such as dissolving, extract with ethanol and cooling the mixture. Winterization may require a freezer to precipitate waxes and a filtration step to remove precipitated solids. Winterization may also require removal of the ethanol from the mixture. For example, winterization may occur at −40° C.

As used herein, the term “wiped film column” refers to a unit in a distillation process for separating two or more components. For example, a wiped film column may include a molecular distillation process including a vertical evaporator with a wiper and wiper motor for creating a thin film. The thin film enables thin film evaporation and short path condensation with efficient heat transfer. A condenser may be placed within the evaporator. Wiped film columns are capable of operating at high temperatures and reduced pressures to enable separation based on vapor pressures and boiling points. Wiped film columns may be utilized for heat sensitive and highly viscous fluids.

### Discussion

Typical botanical extraction techniques utilize a batch process to produce a purified extract. In this batch process, the purified extract must be produced by many separate steps, and the purified extract is susceptible to environmental cross-contamination. Therefore, these batch processes include quality control issues while inefficiently producing the purified extract. Batch processes typically have a reduced yield due to transfer losses between each system. The systems in a batch process are not typically connected due to temperature differentials, pressure differentials, and stability of the compounds. Further, these systems have not been connected due to the presence of one or more solvents and the chemical makeup of the target compounds. Therefore, there exists a need for a continuous botanical extraction process, that enables interoperability, to reduce or prevent contamination and efficiently produce extracts.

Conventionally, products are extracted as a step in a batch process. This multi-step batch process typically includes extraction, winterization, solvent removal, decarboxylation, and distillation. If the oil is extracted with carbon dioxide, winterization typically occurs after extraction. Winterization involves dissolving waxes and oils in ethanol and occurs at a temperature around −40° C. This winterization step requires a freezer and a filtration step. If the oil is extracted with low temperature ethanol, winterization may not be required, and the oil is transferred to a solvent removal step. In each case, the batch process requires a solvent removal step for removing ethanol. Next, the remaining oil is normally decarboxylated and distilled. Importantly, this process includes material losses and cross-contamination risks, increased labor cost and overhead, decreased yield, and increased solvent usage.

Embodiments of the present disclosure provide a novel technique for processing botanicals. This design eliminates typical processing steps (such as winterization and solvent removal) and reduces or prevents any airborne contamination by containing the transfers between the processes and continuously processing the biomass. Therefore, this design reduces operating costs, reduces quality control issues, and eliminates the typical batch process. Due to these novel systems, this biomass extraction process is capable of operating from extraction to distillation without utilizing extraction solvents such as hydrocarbons and ethanol. Further, embodiments of the present disclosure can produce products with increased purity, potency, and clarity-while the system is under control at each stage of the process. Further, embodiments of the present disclosure can produce products with targeted purity, potency and clarity. Further, embodiments of the present disclosure can produce products with similar or greater potency and purity than a process that incorporates winterization. Further documents of the present disclosure can produce isolated products with high potency in a continuous biomass extraction and purification process.

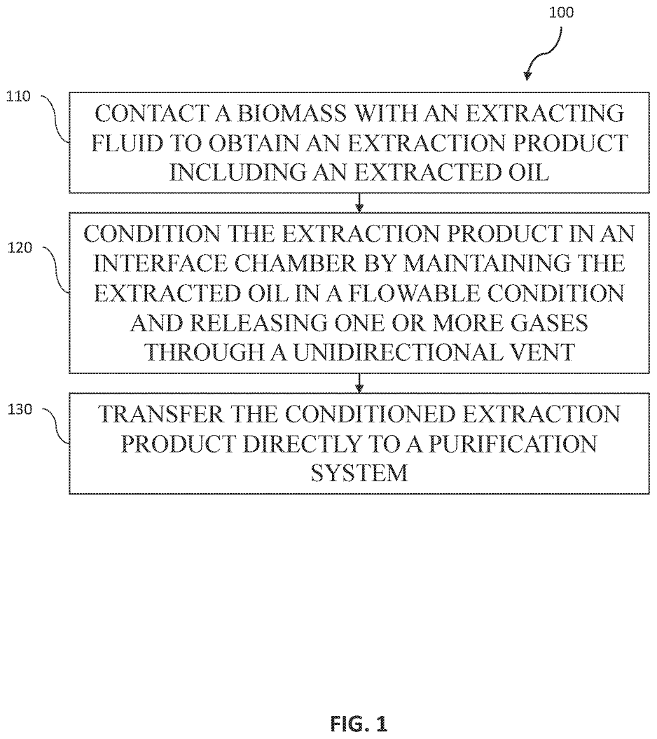

Referring to FIG. 1, a method 100 of converting a botanical-based biomass to an extract in a continuous process is illustrated. The method 100 includes the following steps:

STEP 110, CONTACT A BIOMASS WITH AN EXTRACTING FLUID TO OBTAIN AN EXTRACTION PRODUCT INCLUDING AN EXTRACTED OIL, includes contacting a biomass, such as a decarboxylated biomass, with an extracting fluid, such as carbon dioxide, to obtain an extraction product including an extracted oil. The extracting fluid may have a vapor pressure less than atmospheric pressure. The biomass may be decarboxylated prior to extraction. In one example, decarboxylating the biomass prior to extraction enables gentle harvesting of volatile terpenes and essential oils that may be incorporated into the herbal material. In another example, the biomass includes biomass from the Cannabis genus. The biomass may be in the form of a solid, ground biomass and may be extracted with an extraction system of the present disclosure. The extraction product may be obtained in one or more extractors.

The biomass may be contacted with an extracting fluid such as carbon dioxide, butane, propane, and ethanol. For example, the extracting fluid may include liquid and/or supercritical carbon dioxide. In one example, the biomass is contacted with the extracting fluid at a pressure between 300 psi and 6000 psi. In another example, the biomass is contacted with the extracting fluid at a pressure between 2000 psi and 5500 psi. In yet another example, the biomass is contacted with the extracting fluid between 4000 psi and 5000 psi. The process pressure may be maintained higher than the vapor pressure of the components in the extraction process.

The biomass may be contacted with an extracting fluid at a temperature below 100° C. For example, the biomass may be contacted with an extracting fluid at a temperature between −10° C. to 45° C. In one example, the extraction product includes an extracted oil (desired product) and the extracting fluid. The extraction product may also include water and volatile organic compounds. In one example, the extracted oil includes Cannabis extracts such as cannabinoids, terpenes, and flavonoids. For example, the extracted oil may include CBD and THC. In another example, a cosolvent extracting fluid system is utilized including ethanol and carbon dioxide. In yet another example, low temperature and low pressure carbon dioxide may be utilized to extract terpenes which may be recovered in one or more interface systems. In yet another example, low temperature and high pressure carbon dioxide may be utilized for quick extraction;

STEP 120, CONDITION THE EXTRACTION PRODUCT IN AN INTERFACE CHAMBER BY MAINTAINING THE EXTRACTED OIL IN A FLOWABLE CONDITION AND RELEASING ONE OR MORE gasses THROUGH A UNIDIRECTIONAL VENT, includes conditioning the extraction product, including the extracted oil, in an interface chamber. The extraction product may be transferred directly to the interface chamber from extraction. For example, the extraction system may be in direct fluidic communication with the interface chamber. Conditioning the extraction product by maintaining the extracted oil in a flowable condition may include heating and/or mixing the extracted oil. Heating the extracted oil may include any temperature sufficient to maintain the flowable condition. Heating the extracted oil may include transferring the extraction product to the interface chamber in a jacketed pipe. Further, heating the extracted oil may include modulating a heat applicator in response to a temperature sensor in the vessel chamber or a vessel inlet pipe. Maintaining the flowable condition may include preventing solidification and/or maintaining the extracted oil at a viscosity less than 100 cP.

In one example, the extracted oil is maintained at a temperature above 30° C. In another example, the extracted oil is maintained at a temperature between 40° C. and 150° C. In yet another example, the extracted oil is maintained at a temperature between 50° C. and 100° C. The interface chamber may be a stirred vessel and may be a vessel with a maximum allowable working pressure (MAWP) of 1000-5000 psi. In another example, the interface chamber may have a MAWP of less than 50 psi. In yet another example, the interface chamber may have a MAWP of less than 10 psi. In this example, the input to the interface must pressure monitored to ensure the pressure is equal to or less than the MAWP. The interface chamber may be maintained at a pressure below 100 psi. For example, the interface chamber may be maintained at a pressure below 10 psi. This interface chamber allows the continuous connection of high pressure extraction equipment to lower pressure downstream purification equipment.

Maintaining the extracted oil in a flowable condition is important since the extracted oil can easily solidify. For example, the extraction process may utilize carbon dioxide that is a liquid or supercritical fluid at high pressures. This carbon dioxide starts to expand to a gas upon reaching a lower pressure in the interface vessel. The phase transition is capable of cooling extracted oil and preventing flowability. This can produce a high flow of material into a receiving vessel in a brief amount of time. Typically, this requires close monitoring by an operator. Further, the extracted oil can solidify or become too viscous to flow through the system without conditioning, even without any cooling from carbon dioxide. Therefore, it is vital to condition the extraction product after extraction and provide a system for the automated transfer of the extraction product to the interface vessel.

Conditioning the extraction product by releasing the gas through the unidirectional vent includes releasing a gas such as carbon dioxide. For example, liquid carbon dioxide in an extraction unit expands to a gas upon transfer from the extraction unit. In one example, the released gas may include an inert gas. In another example, the released gas may include one or more of carbon dioxide, ethanol, terpenes, butane, and propane. Releasing gas is important to condition the extraction product for downstream processing and to prevent excess pressure in systems such as the interface system. Further, releasing gas allows for the direct connection of high pressure systems to low pressure systems (such as downstream purification systems). The unidirectional vent may include a check valve that maintains a very low backpressure even with high vent flow. The unidirectional vent check valve importantly prevents backflow (only allowing gas to exit the interface chamber). Preventing backflow is important to prevent cross-contamination. The unidirectional vent is designed to allow unidirectional gas expansion so that the pressure in the interface chamber is less than 10 psi. A vacuum may also be installed in the vent to assist in gas movement from the chamber. For example, a vacuum may be installed prior to a vent check valve. Alternatively, or in addition, a condenser may be installed within the vent or downstream from the vent sufficient to condense desirable or process fluids.

As stated, the vent check valve may prevent backflow of exhaust from the environment to the vessel chamber. Backflow may occur when there is a thermal difference between the outlet and the temperature of the vessel. Backflow may also occur due to pressure differentials between the external exhaust area and the pressure inside the vessel chamber. One or more check valves may be installed in line with the vent exhaust piping to reduce or eliminate the risk of cross contamination. The vent check valve may be a large enough diameter to maintain the pressure in the vessel chamber as expanding gas enters the vessel chamber. In one non-limiting example, the vent check valve is a 4 inch check valve. The check valve may be constructed from a spherical stainless steel or plastic sphere. Other anti-backflow valves such as flapper valves may be utilized to prevent backflow to the system. The pressure in the system may also be maintained by high pressure pneumatic ball valves, manual needle valves, sanitary valves, and solenoid valves. A pressure sensor in the vessel chamber may turn off a solenoid valve for input extract fluid to prevent overpressure of the vessel chamber.

Conditioning may include passing a sweep fluid through the interface chamber to remove a condensable fluid from the interface chamber. The condensable fluid may be present in the extraction product. The sweep fluid may include an inert gas. In one example, the sweep fluid may include one or more of air, argon, carbon dioxide, and nitrogen. The condensable fluid may include one or more of water and volatile organic compounds. Water may be dissolved in the extracted oil after extraction. The sweep fluid may be added to prevent condensation of the water on surfaces in the interface chamber. Instead, the water may be swept toward a vent and condensed in the vent line or exhausted. Further, the sweep fluid may be heated by a heat exchanger to prevent liquid condensation in the vessel chamber. This may prevent condensation by cool fluid introduction to the headspace of the vessel chamber. In one example, the sweep fluid may be heated to prevent water condensation on the top of the vessel chamber. In another example, the sweep fluid heat exchanger is installed between the sweep fluid source and the vessel chamber. In yet another example, the sweep fluid heat exchanger is a stainless steel plate heat exchanger.

In another example, removing the condensable fluid from the interface chamber includes directing the sweep fluid along a sweep path through the unidirectional vent sufficient to direct the condensable fluid to a condenser. For example, the sweep fluid may assist in moving gasses toward the vent in the interface chamber. The sweep fluid may flow through the interface chamber and occupy space above the extraction product/extracted oil. The sweep fluid may flow in a forward direction, such as from an inlet towards the vent. Additionally, the sweep fluid may also be utilized to condition the extraction product by preventing oxidation of the extracted oil and by preventing condensation in the interface chamber. By removing condensable fluids and/or volatile reaction products from the process, the conditioned extraction product may be transferred directly to downstream systems without the need for extra processing steps.

Conditioning the extraction product may include lowering the boiling point of volatiles in the extraction product. Lowering the boiling point may be sufficient to increase the efficiency of removing volatiles. Further, conditioning may include mixing the extraction product sufficient for convection and degassing of the extraction product. Conditioning the extraction product may be completed without winterizing and filtering extracted oil. Compared to traditional batch processes, this process makes extraction to distillation interoperable so that winterization is not required. Importantly, removing the winterization step can decrease solvent usage, decrease energy cost, and improve yields;

STEP 130, TRANSFER THE CONDITIONED EXTRACTION PRODUCT DIRECTLY TO A PURIFICATION SYSTEM, includes transferring, such as through a pipe, the conditioned extraction product directly to a purification system. A direct transfer may include transferring without otherwise filtering, purifying, separating, and/or adding additional components. A direct transfer may include substantially maintaining the temperature of the conditioned extraction product. The purification system may be in fluidic communication with the interface chamber. One or more pumps may be utilized to transfer the conditioned extraction product to the purification system. For example, two or more pumps with different flow rates may be utilized depending on the desired inlet flow rate for the downstream system. The flow rate may be increased or decreased based on the temperature of the interface chamber or based on the desired output concentration of the purification system. Further, the flow rate may be adjusted according to the interface chamber level.

The purification system may include a distillation system, dewaxing system, crystallization system, and chromatography system. For example, purifying the conditioned extraction product includes at least one of distilling the conditioned extraction product into two or more components, crystallizing at least one component of the conditioned extraction product, and or chromatographically separating the conditioned extraction product into two or more components. The purification system may purify the conditioned extraction product by isolating a target fraction from the conditioned extraction product. For example, the target fraction may include one or more of cannabinoid distillate, solid isolate, and liquid isolate.

Distillation may include a distillation system of the present disclosure and may be utilized to separate a distillate from a residue component. For example, distillation may include separating two or more components to purify a cannabinoid. Further, distillation involving the methods of the present disclosure may not require a gas/solvent stripping stage prior to distillation. Typically, a gas/solvent stripping stage is the first stage of distillation. Chromatography may include solvent recovery. For example, chromatography may include separating two or more cannabinoids such as CBD and THC. Crystallization may include producing a purified solid cannabinoid such as CBD isolate and CBD crystals. Crystallization may include utilizing a carbon dioxide or pentane reactor to isolate the cannabinoid.

In a cosolvent extraction system, the output may include an extract, carbon dioxide, and ethanol. This extraction product may be transferred directly to the interface chamber. Following the interface chamber, the product may be transferred to a falling film evaporator or packed bed reactor. In one example, the falling film evaporator may be operated at a temperature between 80° C. and 100° C. This evaporator may remove ethanol. In line packed bed reactors that are commonly practiced in the art may be deployed at high temperatures of 100° C. to 150° C. to decarboxylate the product, and the ethanol may be transferred to a condenser. If the extract includes terpenes, volatile terpenes will typically be evaporated with the ethanol. The evaporator may also recirculate one or more components back to the interface chamber including the non volatile terpene fraction.

Importantly, method 100 may be operated in a continuous process and can improve overall yields. Conventionally, many operations utilize discontinuous processes to produce a product. One of the key issues associated with discontinuous processes is exposing the product to external contamination, especially between the distinct units. Disconnected process units require a large amount of quality documentation, high inventory costs, and expensive operating costs. Further, disconnected process units increase the risk of human exposure to harmful substances and ultimately produce a lower yield, due to transfer losses between distinct units. Harmful substances also require containment systems such as glove boxes, filtration hoods, and automated fill and dispense equipment to limit human exposure. A continuous process all but eliminates human exposure risk by eliminating external contamination risk. Additionally, longer production times and cycle times are a result of a discontinuous process. Method 100 operates continuously and is capable producing an extraction product, such as distillate directly from an extract, without ethanol. Elimination of ethanol based winterization eliminates a high cost operation and discontinuous operation. For example, food grade ethanol costs about 10 times more than liquid carbon dioxide. Further, carbon dioxide does not leave any residues. Method 100 however, may also operate by continuously delivering extraction product to a continuous downstream winterization system. The winterization system in this case may receive the extraction product from the interface chamber and purify the extraction product by improving its potency and removing plant matrix.

Process controls utilize a series of sensors to maintain the equipment and process under constant control. For example, a thermocouple downstream of a flowing fluid may provide feedback to a heater situated upstream of the flowing fluid. A level sensor may provide feedback to an upstream or downstream pump to maintain the desired level in a vessel. Additionally, the flow rate of extraction product may be adjusted according to the desired output concentration. In the case of a batch process where there is a risk of exposure of the extract to the external environment, facilities are considered critical and are highly engineered to eliminate particles in the air. Further, clean rooms are required for certain unit processes. Containment in the present system eliminates a need for critical room status. Also, containment eliminates diversion risk. One key advantage for fully contained operation, Is that the requirements for the control of particulates, humidity and temperature, may be relaxed which results in a significant impact on building cost and facility design. For example, such systems may be deployed in controlled not classified (CNC) areas instead of controlled and classified areas such as ISO 8, ISO 7, ISO 6 clean rooms. Controlling the extraction process at each point in the process ensures quality control of the extraction product.

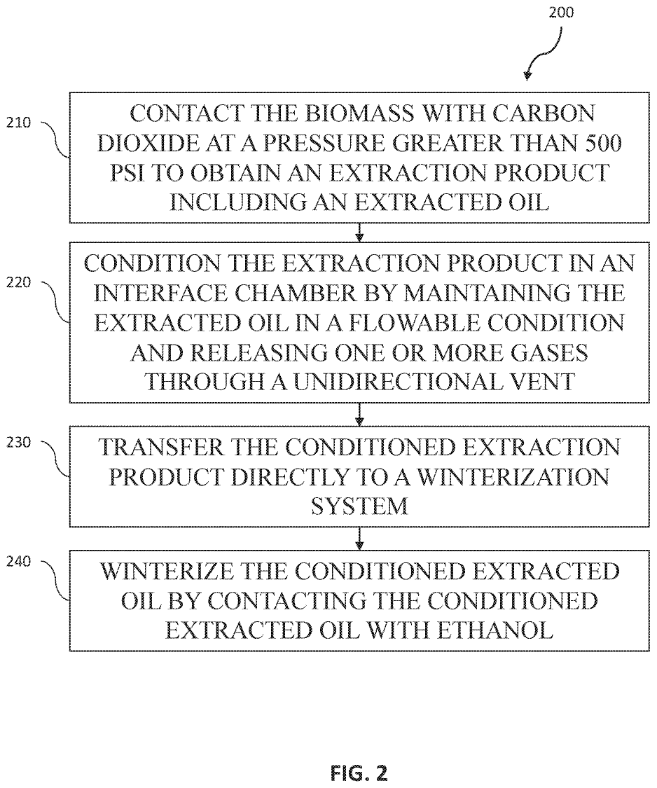

Referring to FIG. 2, a method 200 of converting a botanical-based biomass to an extract in a continuous process is illustrated. The method 200 includes the following steps:

STEP 210, CONTACT THE BIOMASS WITH CARBON DIOXIDE AT A PRESSURE GREATER THAN 500 PSI TO OBTAIN AN EXTRACTION PRODUCT INCLUDING AN EXTRACTED OIL, includes contacting a biomass, such as a decarboxylated biomass, with carbon dioxide (such as liquid carbon dioxide) at a pressure greater than 500 psi. The biomass may be decarboxylated prior to extraction and may be contacted with ethanol during extraction. In one example, decarboxylating the biomass prior to extraction enables gentle harvesting of volatile terpenes and essential oils that may be incorporated into the herbal material. In another example, the biomass includes biomass from the Cannabis genus. The biomass may be in the form of a solid, ground biomass. The extraction product may be obtained in one or more extractors.

The carbon dioxide may include liquid and/or supercritical carbon dioxide. In one example, the biomass is contacted with the carbon dioxide at a pressure between 500 psi and 6000 psi. In another example, the biomass is contacted with the carbon dioxide at a pressure between 2000 psi and 5500 psi. In yet another example, the biomass is contacted with the carbon dioxide between 4000 psi and 5000 psi.

The biomass may be contacted with the carbon dioxide at a temperature below 60° C. For example, the biomass may be contacted with the carbon dioxide at a temperature between −10° C. to 45° C. In one example, the extraction product includes one or more extracted oil, liquid carbon dioxide, volatile organics, and water. The extracted oil may include Cannabis extracts such as cannabinoids, terpenes, and flavonoids. For example, the extracted oil may include CBD and THC;

STEP 220, CONDITION THE EXTRACTION PRODUCT IN AN INTERFACE CHAMBER BY MAINTAINING THE EXTRACTED OIL IN A FLOWABLE CONDITION AND RELEASING ONE OR MORE gasses THROUGH A UNIDIRECTIONAL VENT, includes conditioning the extraction product, including the extracted oil, in an interface chamber. The extraction product may be transferred directly to the interface chamber from extraction. For example, the extraction system may be in direct fluidic communication with the interface chamber. Conditioning the extraction product by maintaining the extracted oil in a flowable condition may include heating and/or mixing the extracted oil. Heating the extracted oil may include any temperature sufficient to maintain the flowable condition. Heating the extracted oil may include transferring the extraction product to the interface chamber in a jacketed pipe. Further, heating the extracted oil may include modulating a heat applicator in response to a temperature sensor in the vessel chamber or a vessel inlet pipe. Maintaining the flowable condition may include preventing solidification and/or maintaining the extracted oil at a viscosity less than 100 cP, or at a viscosity that prevents cavitation.

In one example, the extracted oil is maintained at a temperature above 30° C. In another example, the extracted oil is maintained at a temperature between 40° C. and 150° C. In yet another example, the extracted oil is maintained at a temperature between 50° C. and 100° C. The interface chamber may be maintained below the MAWP of the chamber. In one example, the interface chamber may be maintained at a pressure below 100 psi. In another example, the interface chamber may be maintained at a pressure below 50 psi. For example, the interface chamber may be maintained at a pressure below 10 psi. This interface chamber allows the continuous connection of high pressure extraction equipment to lower pressure downstream purification equipment.

Maintaining the extracted oil in a flowable condition is important since the extracted oil can easily solidify. For example, the extraction process may utilize carbon dioxide that is a liquid or supercritical fluid at high pressures. This carbon dioxide starts to expand to a gas upon reaching a lower pressure. The phase transition is capable of cooling extracted oil and preventing flowability. This can produce a high flow of material into a receiving vessel in a brief amount of time. Typically, this requires close monitoring by an operator. Further, the extracted oil can solidify or become too viscous to flow through the system without conditioning, even without any cooling from carbon dioxide. Therefore, it is vital to condition the extraction product after extraction.

Conditioning the extraction product by releasing the gas through the unidirectional vent includes releasing a gas such as carbon dioxide. For example, liquid carbon dioxide in an extraction unit expands to a gas upon transfer from the extraction unit. In one example, the released gas may include an inert gas. In another example, the released gas may include one or more of carbon dioxide, butane, and propane. Releasing gas is important to condition the extraction product for downstream processing and to prevent excess pressure in systems such as the interface system. Further, releasing gas allows for the direct connection of high pressure systems to low pressure systems (such as downstream purification systems). The unidirectional vent may include a check valve within the vent sufficient to prevent backflow (only allowing gas to exit the interface chamber). The unidirectional vent may maintain the pressure in the interface chamber at a pressure less than 10 psi. A vacuum may also be installed in the vent. For example, a vacuum may be installed prior to a vent check valve. Alternatively, or in addition, a condenser may be installed within the vent or downstream from the vent sufficient to aid in the action of condensing fluids.

Conditioning may include passing a sweep fluid through the interface chamber to remove a condensable fluid from the interface chamber. The condensable fluid may be present in the extraction product. The sweep fluid may include an inert gas. In one example, the sweep fluid may include one or more of air, argon, carbon dioxide, and nitrogen. The condensable fluid may include one or more of water and volatile organic compounds. Water may be dissolved in the extracted oil after extraction. The sweep fluid may be added to prevent condensation of the water in the interface chamber. Instead, the water may be swept toward a vent and condensed in the vent line. Further, the sweep fluid may be heated by a heat exchanger to prevent liquid condensation in the vessel chamber.

In another example, removing the condensable fluid from the interface chamber includes directing the sweep fluid along a sweep path through the unidirectional vent sufficient to direct the condensable fluid to a condenser. For example, the sweep fluid may assist in moving gasses toward the vent in the interface chamber. The sweep fluid may flow through the interface chamber and occupy space above the extraction product/extracted oil. The sweep fluid may flow in a forward direction, such as from an inlet towards the vent. Additionally, the sweep fluid may also be utilized to condition the extraction product by preventing oxidation of the extracted oil and by preventing condensation in the interface chamber. By removing condensable fluids from the process, the conditioned extraction product may be transferred directly to downstream systems without the need for extra processing steps.

Conditioning the extraction product may include lowering the boiling point of volatiles in the extraction product. Lowering the boiling point may be sufficient to increase the efficiency of removing volatiles. Further, conditioning may include mixing the extraction product sufficient for convection and degassing of the extraction product. Conditioning the extraction product may be completed without winterizing and filtering extracted oil. Compared to traditional processes, this process does not require winterizing (typically with ethanol and a freezer) and filtering the extracted oil. Importantly, removing this step can decrease solvent usage, decrease energy cost, and improve yields;

STEP 230, TRANSFER THE CONDITIONED EXTRACTION PRODUCT DIRECTLY TO A WINTERIZATION SYSTEM, includes transferring the conditioned extraction product directly to a winterization system, such as a system including a stirred, jacketed vessel that contains chilled ethanol and a downstream filter to filter waxes. A direct transfer may include substantially maintaining the temperature of the conditioned extraction product. One or more pumps may be utilized to transfer the conditioned extraction product;

STEP 240, WINTERIZE THE CONDITIONED EXTRACTED OIL BY CONTACTING THE CONDITIONED EXTRACTED OIL WITH ETHANOL, includes winterizing by contacting the conditioned extracted oil with cold ethanol in a controlled temperature, stirred vessel. Winterization may include one or more falling film evaporators and condensers for rapid solvent recovery. This system may also include a packed bed reactor for high evaporation performance and integrated decarboxylation. Packing materials range from catalytic materials that are capable of decarboxylation or inert materials that are incapable of decarboxylation. The packing materials may be spherical or oblong, or maybe of various shapes to enable a high surface area and complete flowability and heat transfer within the reactor. Winterization may also include a vacuum filtration apparatus such as a drum filtration apparatus or a membrane filtration apparatus as is commonly known in the art. This filtration system can remove waxes from winterized ethanol solutions. The advantage of a drum filtration apparatus is that it can be configured to be continuous as compared to a membrane filtration apparatus that will typically require discontinuous operation. A direct transfer may include transferring without otherwise filtering, purifying, separating, and/or adding additional components. STEP 240 may include using a winterization system of the present disclosure.

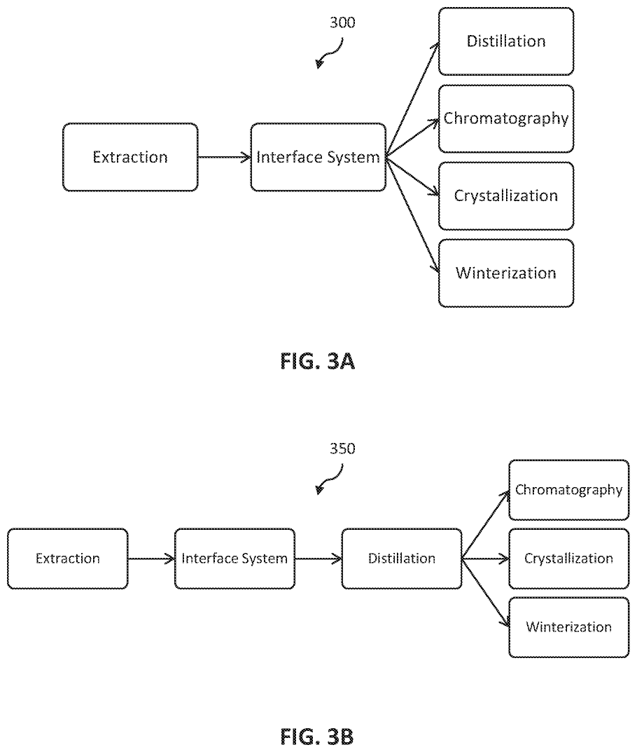

FIG. 3A illustrates a process flow diagram 300 for botanical extraction, according to some embodiments. Process flow diagram 300 displays a novel pathway for biomass extraction to produce a single extract in various forms including purified and potent oils, crystals or fractions. As shown in FIG. 3A, extraction takes place first, followed by interface conditioning. Because of this novel conditioning step, the extraction product may be transferred to a distillation system, a chromatography system, a crystallization system, and/or winterization system, without external exposure. One or more interface devices, maybe used in between each process to control mass flow and maintain flow ability. Such interface device would include a jacket for maintaining the temperature, a sensor for controlling the mass flow out of the interface device, and a pump with flow rate controls for material conveyance from Process to Process.

FIG. 3B illustrates a process flow diagram 350 for botanical extraction, according to some embodiments. Process flow diagram 350 displays a novel pathway for biomass extraction without external exposure. As shown in FIG. 3B, extraction takes place first, followed by interface conditioning. Because of this novel conditioning step, the extraction product may be transferred directly to distillation. Control of distillation can enable targeted potency fractions to be delivered to downstream purification apparatus. The extraction product can be purified with a distillation system, and can be subsequently transferred to a chromatography system, a crystallization system, and/or a winterization system after distillation.

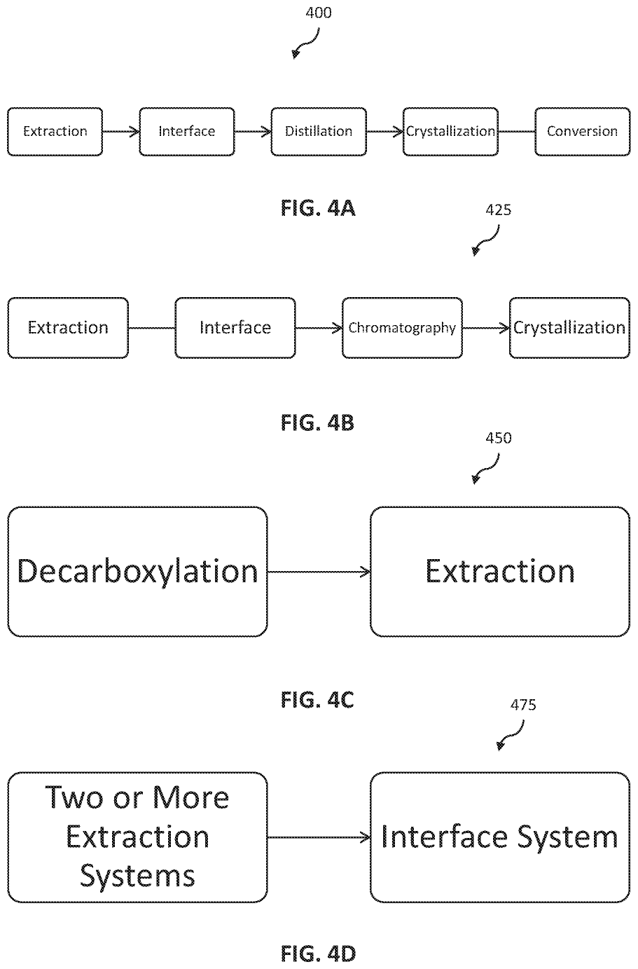

FIG. 4A illustrates a process flow diagram 400 for botanical extraction, according to some embodiments. Process flow diagram 400 displays a novel pathway for continuous and contained biomass extraction. As shown in FIG. 4A, extraction takes place first, followed by interface conditioning. After the extracted product is moved to the interface system, the extraction production may be transferred to distillation and optionally crystallization and/or conversion. Conversion may be utilized to purify/chemically convert one or more cannabinoids. For example, conversion may be utilized to convert CBD to Delta 8 THC.

FIG. 4B illustrates a process flow diagram 425 for botanical extraction, according to some embodiments. FIG. 4B displays that after extraction, the extraction product may be transferred to a the interface system, chromatography system, and optionally a crystallization system after chromatography. FIG. 4C illustrates a process flow diagram 450 for botanical extraction, according to some embodiments. Decarboxylation may be performed prior to extraction in the methods of the present disclosure. Conventionally, extracted oil is winterized and then decarboxylated and filtered before distillation. Typically, decarboxylation requires a decarboxylation reactor prior to distillation. Importantly, biomass may be decarboxylated prior to extraction in the methods of the present disclosure. Decarboxylation prior to extraction may include vacuum ovens, which can increase extraction efficiency. FIG. 4D illustrates a process flow diagram 475 for botanical extraction, according to some embodiments. As shown, multiple extraction units may be connected to the interface system. These extraction units may simultaneously transfer extraction product to the interface system. Multiple interface systems may be utilized for increased capacity. Further, the volume of the interface system may be increased to handle an increased capacity.

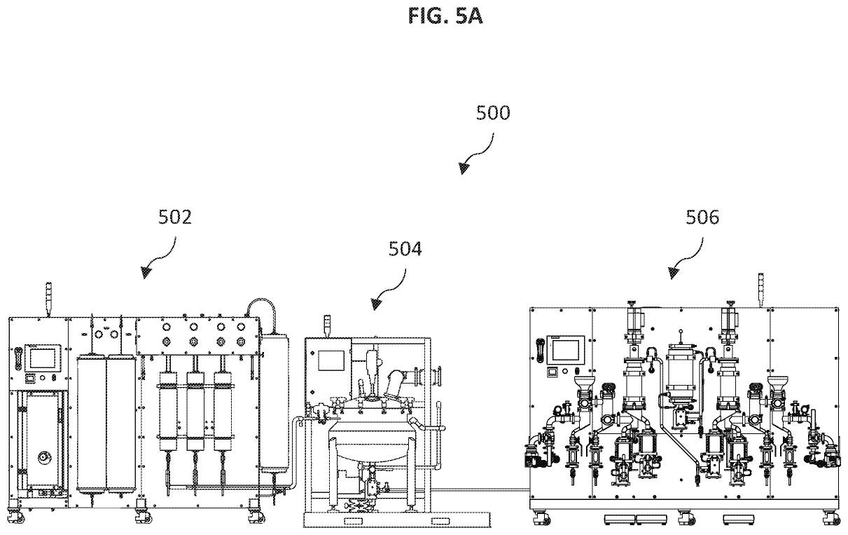

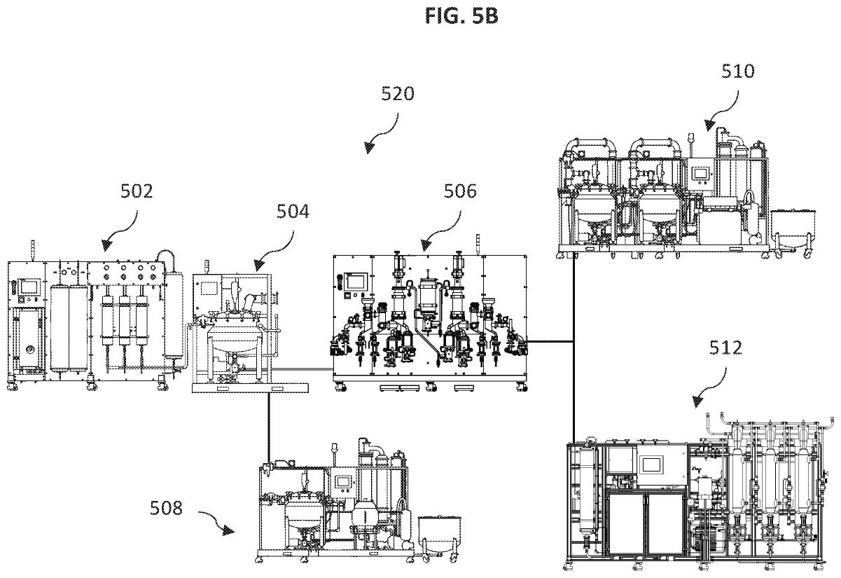

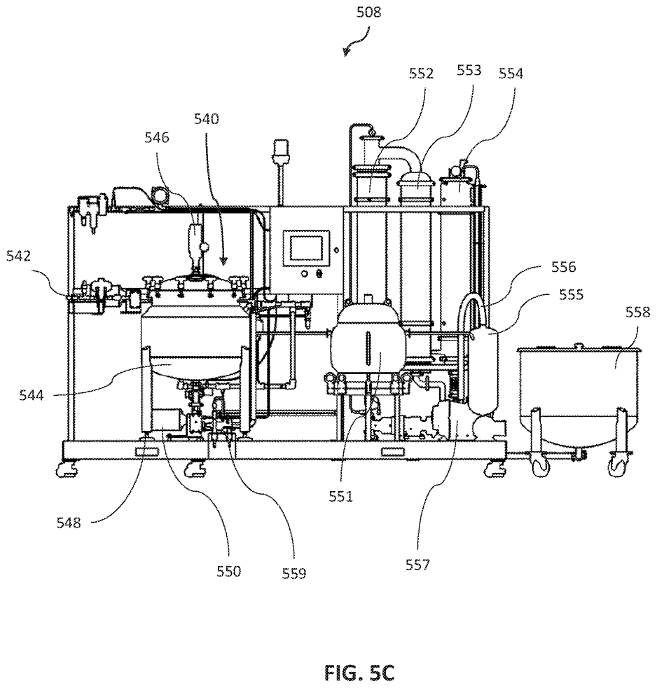

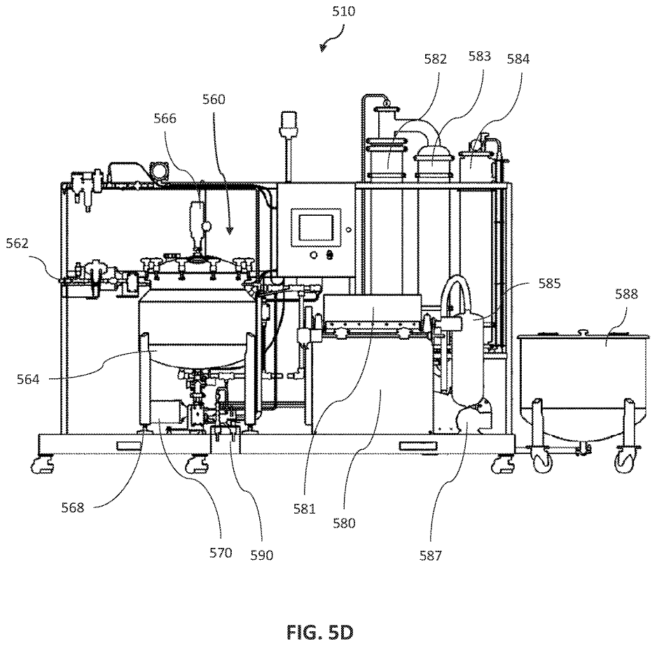

FIG. 5A illustrates an extraction to distillation process 500, according to some embodiments. FIG. 5A illustrates extraction system 502, interface system 504, and distillation system 506. This process is one example of the process shown in FIG. 3A. FIG. 5B illustrates an extraction to distillation process 520, with optional downstream processes, according to some embodiments. FIG. 5B illustrates extraction system 502, interface system 504, distillation system 506, winterization system 508, crystallization system 510, and chromatography system 512. As shown in FIGS. 5A and 5B, the interface system allows the direct transfer from extraction to distillation and from extraction to winterization. Further, an interface vessel may be utilized between distillation system 506 and chromatography system 512. This process is one example of the processes shown in FIG. 3A and FIG. 3B. Extraction to distillation process 500 may be utilized for method 100.

FIG. 5C illustrates a schematic of a winterization system 508, according to some embodiments. This system is one example of a system shown in FIG. 3A. Winterization system 508 includes tank 540, input 542, thermal element 544, mixer 546, load cell 548, exit pump 550, filter 551, evaporator 552, condenser 553, solvent reservoir 554, condenser 555, piping 556, vacuum pump 557, vessel 558, and clean-in-place connection 559. The interface system 504 may transfer conditioned extraction product directly to the winterization system 508 via input 542. Winterization system 508 provides an automated design to dewax extracts. The winterization system 508 may include an automated ethanol mixing and a dilution tank, such as tank 540, that is insulated and cooled with a chiller, such as thermal element 544. In one example, tank 540 has a volume ranging from about 20 L to about 100 L. In another example, tank 540 has a volume of about 50 L. Thermal element 544 may include a heater. The conditioned extraction product may enter tank 540 via input 542 and ethanol may be added to tank 540 at any temperature, such as room temperature.

All components may be added by weight, and one or more load cells 548 may be utilized to weigh the components in tank 540. For example, load cells 548 may turn any pump on or off based on the total weight in tank 540. A homogenizer may be utilized for a number of minutes, such as one to five minutes. In one example, the thermal element 544 cools at least a portion of the system to about −40° C. Mixer 546 assists with mixing any components in the tank 540. Additionally, the conditioned extraction product and the ethanol may be mixed for minutes or hours. For example, the conditioned extraction product and the ethanol may be mixed for one to six hours. The exit pump 550 or the vacuum pump 557 may transfer components from tank 540 to filter 551. One or more filters 551 may be utilized in the process. In one example, the maximum pressure in the filter 551 is 50 psi. In another example, the maximum pressure in the filter 551 is 30 psi. And yet another example, the filter is not a depth filter, as is shown in the figure. But rather is a drum filter that is commonly known in the art.

The winterization system 508 may include a two-stage filtration system, such as filter 551, with a single stage falling film solvent recovery system. For example, supernatant (liquid) moves to the falling film system and ethanol is collected. The falling film system may include evaporator 552, condenser 553, and solvent reservoir 554. In one example, solvent reservoir 554 has a volume range from about 10 L to about 50 L. In another example, solvent reservoir 554 has a volume of about 20 L. Filter 551 and condenser 553 may include chillers, and evaporator 552 may include a heater. Evaporator 552, condenser 553, and solvent reservoir 554 may each include a vacuum connection. Condenser 555 may be utilized to separate ethanol and recycle the ethanol back to tank 540 via piping 556. Winterized product may be transferred from filter 551 to vessel 558 for collection. Winterization system 508 may further include a solid phase extraction module and clean-in-place connections, such as clean-in-place connection 559. Additionally, the winterization system 508 may be utilized for method 200.

FIG. 5D illustrates a schematic of crystallization system 510, according to some embodiments. Crystallization system 510 is sufficient for crystallization of target compounds from distillates. This system is one example of a portion of the system shown in FIG. 4A. Crystallization system 510 includes tank 560, input 562, thermal element 564, mixer 566, load cell 568, exit pump 570, filtration apparatus 580, filtration drum 581, evaporator 582, condenser 583, solvent reservoir 584, condenser 585, vacuum pump 587, vessel 588, and clean in place connection 590. The interface system 504 may transfer conditioned extraction product directly to the tank 560 via input 562. The crystallization system 510 includes the tank 560, such as a mixing and dilution tank, that is insulated and chilled with a recirculating chiller, such as thermal element 564. In one example, tank 560 has a volume ranging from about 20 L to about 100 L. In another example, tank 560 has a volume of about 50 L.

Conditioned extraction product is mixed and a cooled in the tank 560. Mixer 566 may include a motor and a side wall scraper. Before, during, or after mixing, pentane may be added to tank 560. The product is transferred with exit pump 570 from tank 560 to the filtration apparatus 580, which includes a filtration drum 581. Crystallization system 510 may include one or more filtration apparatuses 580. The evaporator 582, condenser 583, and solvent reservoir 584 are sufficient for single stage falling film for solvent recovery. Condenser 585 acts as a solvent trap for solvent recovery. Vacuum pump 587 may include an oil free vacuum pump. The crystallization system 510 may include one or more clean in place connections, such as clean in place connection 590.

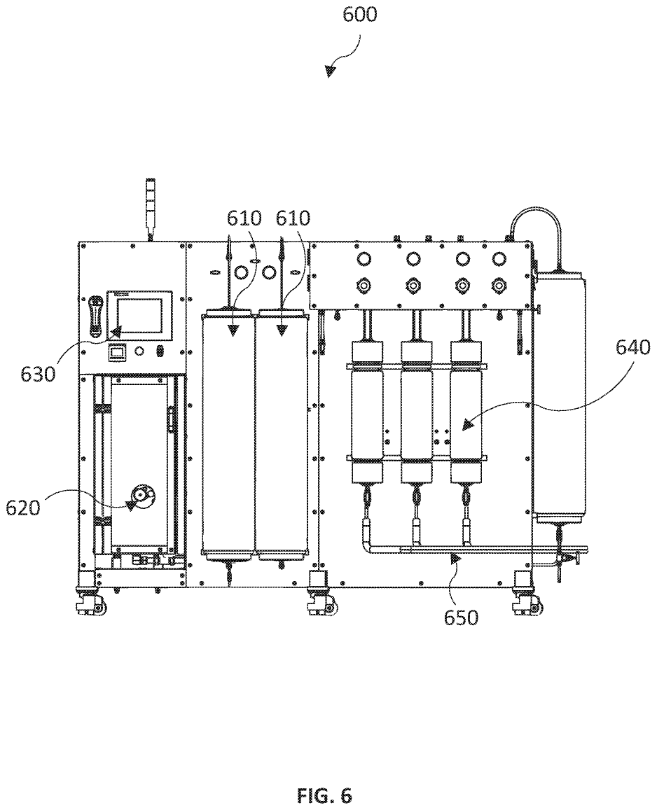

FIG. 6 illustrates an extraction system 600, according to some embodiments. FIG. 6 illustrates extractor 610, pump 620, control system 630, collector 640, and outlet 650. Extraction system 600 is controlled by control system 630 and utilizes carbon dioxide to extract an extraction product from biomass. Extraction system may include one or more extractors 610, one or more pumps 620, and one or more collectors 640. Extractor 610 may operate at pressures up to about 5000 psi. Pump 620 may compress carbon dioxide to a liquid or supercritical state. The temperature within the extractor may be regulated to a desired temperature. For example, the extraction temperature may be below 60° C. Biomass is added to extractor 610 and pump 620 pressurizes extractor 610 with carbon dioxide. The carbon dioxide extracts oil from the biomass to separate an extraction product.

The extraction product, included extracted oil, is transferred to collector 640 following extraction. If more than one collector is used, the pressure can be adjusted to fractionate the extract into different fractions. Collector 640 may include a gravity and/or cyclonic separation unit. The extraction product may leave the extraction system 600 through outlet 650. The outlet 650 may be in direct, fluidic communication with an interface system. The tanks and piping throughout extraction system 600 are jacketed throughout the system to maintain desired temperatures.

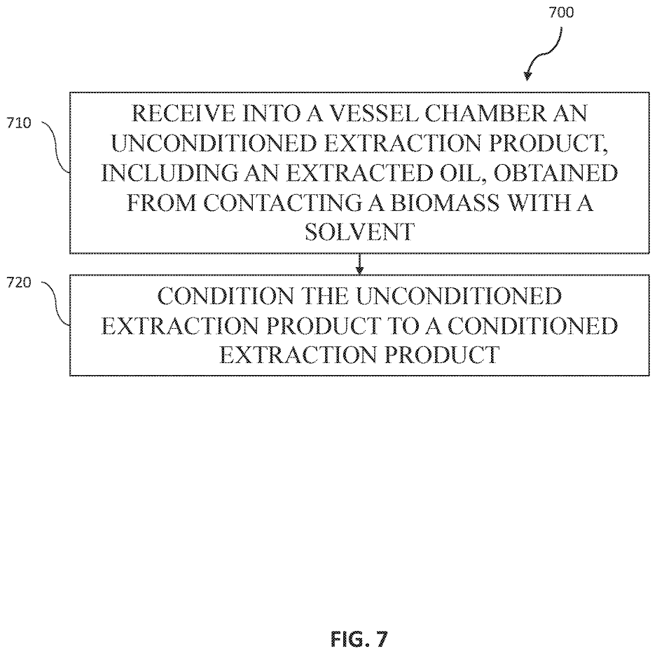

Referring to FIG. 7, a method 700 for conditioning a biomass-based extract is illustrated. The method 700 includes the following steps:

STEP 710, RECEIVE INTO A VESSEL CHAMBER AN UNCONDITIONED EXTRACTION PRODUCT, INCLUDING AN EXTRACTED OIL, OBTAINED FROM CONTACTING A BIOMASS WITH A SOLVENT, includes receiving into a vessel chamber an unconditioned extraction product, including an extracted oil, obtained from contacting a biomass with a solvent, such as carbon dioxide. The unconditioned extraction product may be received directly from an extractor. Further, the vessel chamber may be in fluidic communication with one or more extraction units, such as an extractor or an extraction collector. The unconditioned extraction product may include one or more solvents in addition to the extracted oil. The solvent may include one or more of carbon dioxide, butane, propane, and ethanol. The unconditioned extraction product may include terpenes and condensable fluids. The condensable fluid may include water and volatile organic compounds;

STEP 720, CONDITION THE UNCONDITIONED EXTRACTION PRODUCT TO A CONDITIONED EXTRACTION PRODUCT, includes maintaining the extracted oil in a flowable condition and releasing one or more gasses through a unidirectional vent. Conditioning the unconditioned extraction product further includes maintaining the vessel chamber at an elevated temperature of at least 40° C.

Conditioning the unconditioned extraction product by maintaining the extracted oil in a flowable condition may include heating and/or mixing the extracted oil. Heating the extracted oil may include any temperature sufficient to maintain the flowable condition. Heating the extracted oil may include transferring the extraction product to the vessel chamber in a jacketed pipe. Heating the extracted oil may include modulating a heat applicator in response to a temperature sensor in the vessel chamber or a vessel inlet pipe. Maintaining the flowable condition may include preventing solidification and/or maintaining the extracted oil at a viscosity less than 100 cP. In one example, the extracted oil is maintained at a temperature between 40° C. and 150° C. In another example, the extracted oil is maintained at a temperature between 50° C. and 100° C. The vessel chamber may be maintained at a pressure below 100 psi. For example, the interface chamber may be maintained at a pressure below 10 psi.

Conditioning the unconditioned extraction product by releasing the gas through the unidirectional vent includes releasing a gas such as carbon dioxide. In one example, the released gas may include an inert gas. In another example, the released gas may include one or more of carbon dioxide, butane, and propane. In yet another example, the released gas may include one or more of water and volatile organic compounds. The unidirectional vent may include a check valve within the vent sufficient to prevent backflow (only allowing gas to exit the interface chamber). The unidirectional vent may maintain the pressure in the vessel chamber at a pressure less than 10 psi. Further, a vacuum may also be installed in the vent. For example, a vacuum may be installed prior to a vent check valve. Alternatively, or in addition, a condenser may be installed within the vent or downstream from the vent sufficient to condense fluids.

Conditioning may include passing a sweep fluid through the vessel chamber to remove a condensable fluid from the vessel chamber. The sweep fluid may include an inert gas. In one example, the sweep fluid may include one or more of air, argon, carbon dioxide, and nitrogen. Removing the condensable fluid from the vessel chamber includes directing the sweep fluid along a sweep path through the unidirectional vent sufficient to direct the condensable fluid to a condenser. For example, the sweep fluid may assist in moving/directing gasses toward the vent in the vessel chamber. The sweep fluid may flow through the vessel chamber and occupy space above the extraction product/extracted oil. The sweep fluid may flow in a forward direction, such as from an inlet towards the vent. The sweep fluid may also be utilized to condition the extraction product by preventing oxidation of the extracted oil and by preventing condensation in the vessel chamber.

Conditioning the unconditioned extraction product may include lowering the boiling point of volatiles in the extraction product. Lowering the boiling point may be sufficient to increase the efficiency of condensing and removing volatiles. Further, conditioning may include mixing the unconditioned extraction product sufficient for convection and degassing of the unconditioned extraction product. Compared to traditional processes, this process enables direct distillation without winterization. Further, the conditioned extraction product may be substantially solvent-free. In one example, substantially solvent-free includes less than 10 wt. %, preferably less than 5 wt. %, and more preferably less than 1 wt. % solvent. Solvent-free may include zero solvent. Therefore, removing winterization can decrease solvent usage, decrease energy cost, and improve yields.

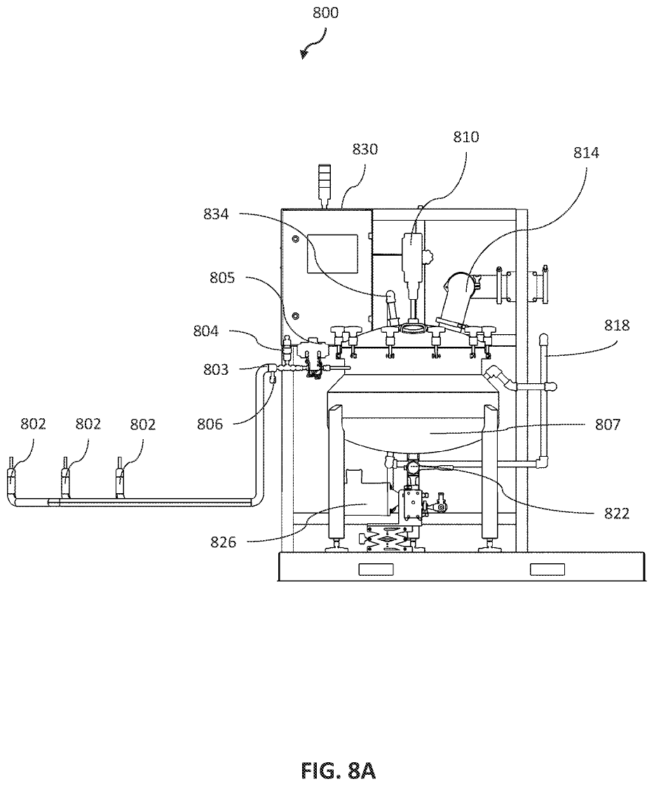

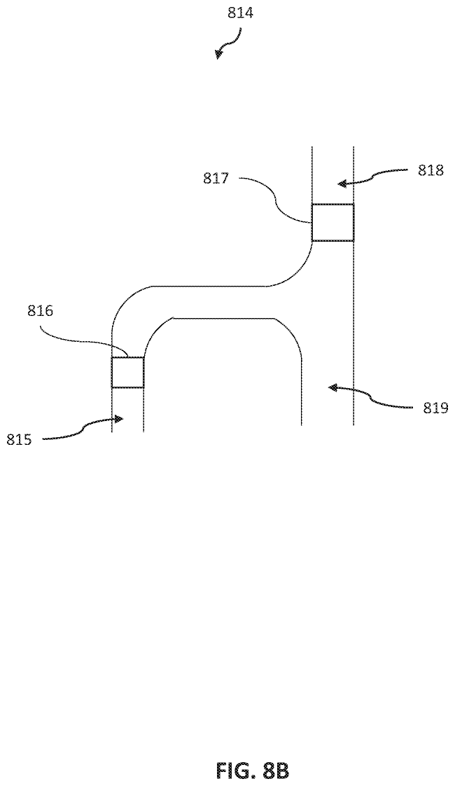

FIG. 8A illustrates an interface system 800, according to some embodiments. FIG. 8A illustrates system inlet 802, chamber inlet 803, pressure relief device 804, valve 805, heater connection 806, vessel chamber 807, mixer motor 810, vent 814, jacket heater 818, chamber outlet 822, pump 826, control system 830, and sweep fluid inlet 834. Interface system 800 conditions an unconditioned extraction product. Extraction product from an extraction system, such as extraction system 600, is transferred through system inlet 802 and chamber inlet 803. Multiple system inlets 802 may be utilized and may converge into one chamber inlet 803 or may separately enter vessel chamber 807. In one example, the number of system inlets 802 may be expanded to accommodate larger systems or multiple different extractors. For example, there may be more than one, such as one to ten system inlets 802. The system inlets 802 may be connected together via a manifold. The piping from system inlet 802 to chamber inlet 803 may be jacketed to maintain an elevated temperature. The heater connection 806 may connect a heater to the jacketing. Valve 805 may open or close depending on the application, such as normal process operation or for a clean-in-place process. Valve 805 may open or close depending on vessel chamber 807 pressure, temperature, level, or weight. Further, the interface system 800 may include weigh cells for measuring the output of oil and the removal of water/volatiles during heating.

The unconditioned extraction product enters the vessel chamber 807 via chamber inlet 803. Once the unconditioned extraction product has entered the vessel chamber 807, this unconditioned extraction product is conditioned. Conditioning the unconditioned extraction product may include maintaining the extracted oil in a flowable condition. Maintaining the extracted oil in a flowable condition may include heating the extracted oil. For example, the vessel chamber 807 may be maintained at a temperature above 30° C. Mixer motor 810 may turn a mixer within the vessel chamber 807 sufficient for convection and maintaining the flowable condition. Mixer motor 810 is shown on top of the vessel chamber 807 but may be on any side of the vessel chamber 807. Mixer motor 810 may turn a mixer blade to assist in degassing within the vessel chamber 807.

Conditioning the unconditioned extraction product may include releasing gas through the vent 814 (further discussed in subsequent Figures). Vent 814 may include one or more of a check valve, a condenser, and a vacuum system. Vent 814 is a unidirectional vent, allowing for gas to exit the vessel chamber 807 and preventing backflow of external air and fluid. In one example, the released gas may include one or more of carbon dioxide, butane, and propane. Vent 814 also assists in maintaining a vessel chamber 807 pressure. For example, the vessel chamber 807 may be maintained at a pressure below about 14.7 psi.

Conditioning the unconditioned extraction product may include releasing condensable fluids through the vent 814. For example, condensable fluids may include one or more of water and volatile organic compounds. A sweep fluid may be utilized to assist in removing these condensable fluids from vessel chamber 807 and may prevent reactions of labile extracts. Therefore, the sweep fluid may also exit the vessel chamber 807 through vent 814. In one example, removing the condensable fluid from the vessel chamber 807 includes directing the sweep fluid along a sweep path toward the vent 803. The sweep fluid may assist in moving fluids toward the vent 814. The sweep fluid may enter through sweep fluid inlet 834 and occupy a space above an extraction product/extracted oil. The sweep fluid may flow in a forward direction, such as from the sweep fluid inlet 834 to vent 814 and may include an inert gas.

Importantly, the vent may maintain safe operating pressures while conditioning the unconditioned extraction product. Further, the vent allows removal of undesired gasses (such as solvents), condensable fluids, and volatile organic compounds. Therefore, the conditioned extraction product may be purified, maintained, and prepared for downstream processes. After conditioning, the conditioned extraction product may exit the vessel chamber 807 through the chamber outlet 822. Pump 826 transfers the conditioned extraction product to downstream processes. Pump 826 may include one or more pumps for simultaneously transferring the conditioned extraction product to distinct downstream processes.

The interface system 800 may include a clean-in-place system. For example, the vessel chamber 807 may include a spray ball (not shown) for spraying cleaning fluid into the vessel chamber 807. The spray ball may provide coverage of the cleaning fluid to the inside surface of vessel chamber 807. The cleaning fluid may be mixed in the vessel chamber 807 and removed from the vessel with a valve or pump 826. The clean-in-place system may be capable of cleaning other systems of the present disclosure at the same time.

FIG. 8B illustrates an example of vent 814, according to some embodiments. Vent 814 may include a vessel connection point 815, check valve 816, condenser 817, exit gas piping 818, and condensed fluid piping 819. FIG. 8B illustrates examples of process components in vent 814 and is not necessarily drawn to scale. Vessel connection point 816 connects to vessel chamber 807, shown in FIG. 8A. Vent 814 includes a check valve 816, which allows for fluid to exit vessel chamber 807 in a unidirectional flow and prevents backflow into vessel chamber 807. Preventing backflow may include preventing any external gasses and/or liquids from entering vessel chamber 807. The check valve 816 may also assist in maintaining safe operating pressures for vessel chamber 807. Check valve 816 may ensure no external contamination enters the process. For example, check valve 816 may maintain vessel chamber 807 at a pressure below 10 psi. In one non-limiting example, check valve 816 is a 4 inch check valve. Check valve 816 may be constructed from a spherical stainless steel or plastic ball. Other anti-backflow valves such as flapper valves may be utilized to prevent backflow to the system.

In one example, condensable fluids containing one or more of water and volatile organic compounds exit vessel chamber 807 and pass through check valve 816. These condensable fluids enter condenser 817, which may be a heat exchanger or chiller. In one example, one or more condensable fluids are condensed and fall toward the condensed fluid piping 819. Any non-condensed components passing through the condenser 817 may exit the vent 814 via exit gas piping 818. For example, a sweep fluid may exit the vent 814 via the exit gas piping 818. Therefore, vent 814 assists in separating volatile organic compounds and/or water that may exit the vent 814 via the condensed fluid piping 819. This enables recovery of the sweep fluid and separation of one or more of solvents, water, and volatile organic compounds. Gas flow sensors may be added to this apparatus upstream or downstream of the check valve to measure a leak condition and provide an alarm of such condition.

The interface system 800 allows for continuous connection of high pressure extraction equipment to lower pressure downstream purification systems. The interface system 800 may also preserve the integrity of the extract including oxidation, humidity, and light exposure. The interface system 800 may eliminate the need for explosion proof or classified equipment. Further, interface system 800 continuously conditions the extracted oil while maintaining a desired temperature and mixing condition to prevent degradation. Further, interface system 800 includes a control system for both upstream and downstream valves, pumps, and sensors to provide proper metering to downstream processes. The interface system 800 may also assist in solvent recovery and may be utilized for method 700. Without interface system 800, many additional steps would be required, such as winterization, decarboxylation and a molecular distillation solvent stripping stage.

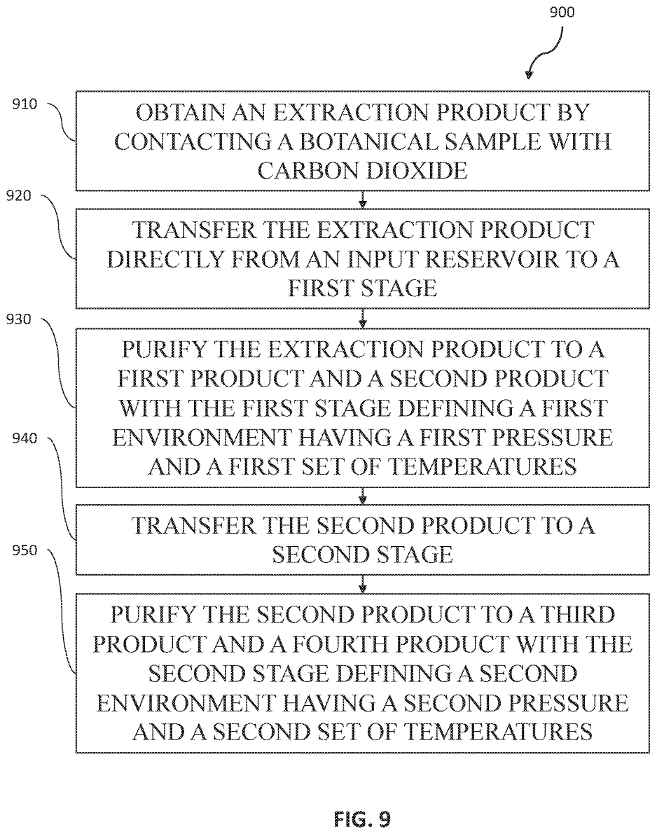

Referring to FIG. 9, a method 900 of purifying a botanical-based extract is illustrated. The method 900 includes the following steps:

STEP 910, OBTAIN AN EXTRACTION PRODUCT BY CONTACTING A BOTANICAL SAMPLE WITH CARBON DIOXIDE, includes obtaining an extraction product by contacting a botanical sample with carbon dioxide in one or more extractors and conditioning the extraction product with the interface system of the present disclosure. The conditioned extraction product may be free of a condensable fluid;

STEP 920, TRANSFER THE EXTRACTION PRODUCT DIRECTLY FROM AN INPUT RESERVOIR TO A FIRST STAGE, includes transferring the extraction product, including conditioned, extracted oil, directly from an input reservoir to a first stage. The input reservoir may receive the extraction product direction from the interface system. The conveyance piping from the interface system to the input reservoir may be heated to maintain a desired temperature and flowability. The interface system may transfer the extraction product to the input reservoir at a flow rate based on the input reservoir level. This input reservoir may heat the extraction product and pump the extraction product directly to the first stage. Importantly, the extraction product can be transferred directly to the first stage without a gas/solvent stripping stage.

The input reservoir level may be monitored with a bubble sensor. The bubble sensor system may include a purge gas supply, a pressure regulator, a needle valve, a rotameter, a pressure sensor, and a dip tube. As the level of extraction product in the input reservoir increases, the pressure increases. The bubble sensor is easy to clean and is fouling resistant. Further, the bubble sensor provides highly accurate results for viscous fluids. The extraction product can be sticky and hot. Therefore, traditional level sensors such as floating balls, lasers, and optical light suffer from fouling, are inaccurate, and are not able to be cleaned. The input pump and/or output pump of the input reservoir may maintain a desired level in the input reservoir;

STEP 930, PURIFY THE EXTRACTION PRODUCT TO A FIRST PRODUCT WITH THE FIRST STAGE DEFINING A FIRST ENVIRONMENT HAVING A FIRST PRESSURE AND A FIRST SET OF TEMPERATURES, includes purifying the extraction product to a first product with the first stage, such as a wiped film column. The first stage includes a first environment including a first pressure and a first set of temperatures sufficient to purify the extraction product. The first stage may produce a distillate product and a residue product. The residue product may include one or more terpenes.

In one example, the first set of temperatures range from about 50° C. to about 300° C. In another example, the first set of temperatures range from about 100° C. to about 250° C. In yet another example, the first set of temperatures range from about 150° C. to about 200° C. The first set of temperatures may include a difference in temperature between an evaporator wall and a condensation finger. A vacuum may decrease the required distillation temperature. The first pressure may be any pressure sufficient for distillation, such as under vacuum. In one example, the first pressure ranges from about 0.01 Torr to about 760 Torr. In another example, the first pressure ranges from about 0.01 Torr to about 0.1 Torr. In yet another example, the first pressure ranges from about 0.02 Torr to about 0.05 Torr.

A wiped film column may be utilized as the first stage to purify the extraction product. A wiped film column may include a motorized wiper, an internal or external condenser, and an outer jacket for heating or cooling. The motorized wipers rotate and create a thin film sufficient for highly efficient heat transfer. A condenser may be located in the center of the wiped film column. This condenser may be cooled for condensing vapor in the wiped film column. The wiped film column produces a distillate and residue product. Typically, the distillate is the targeted product that is collected at a certain boiling point. The residue product may include a feed constituent that does not evaporate during distillation. A vacuum system may include one or more vacuum conditioners designed to condense terpenes and solvents that did not condense on the condenser. Residuals, waxes, fats, chlorophylls, and plant materials that did not boil may be transferred to a second stage for further purification. In one example, purifying the extraction product to a first product occurs in a solvent-free environment;

STEP 940, TRANSFER THE FIRST PRODUCT TO A SECOND STAGE, includes transferring the first product, such as the residue product, to the second stage. Transferring may include pumping the first product to the second stage with a transfer pump. The first product may be heated while being transferred to the second stage;

STEP 950, PURIFY THE FIRST PRODUCT TO A SECOND PRODUCT WITH THE SECOND STAGE DEFINING A SECOND ENVIRONMENT HAVING A SECOND PRESSURE AND A SECOND SET OF TEMPERATURES, includes purifying the first product, such as the residue product, to a second product including a distillate and residue product with a second stage. The second stage includes a second environment including a second pressure and a second set of temperatures sufficient to purify the extraction product.

In one example, the second set of temperatures range from about 50° C. to about 300° C. In another example, the second set of temperatures range from about 100° C. to about 250° C. In yet another example, the second set of temperatures range from about 150° C. to about 200° C. The second set of temperatures may be the same or different temperatures as the first set of temperatures. The second set of temperatures may be greater than the first set of temperatures to obtain a target potency that is substantially similar to the output distillate of the first stage. For example, the first temperature may be below 175° C. and the second temperature may be above 175° C. The second set of temperatures may include a difference in temperature between an evaporator wall and a condensation finger. The second pressure may be any pressure sufficient for distillation, such as under vacuum. In one example, the second pressure ranges from about 0.001 Torr to about 760 Torr. In another example, the second pressure ranges from about 0.001 Torr to about 0.1 Torr. In yet another example, the second pressure ranges from about 0.002 Torr to about 0.02 Torr. The second pressure may be the same or different pressure as the first pressure. For example, the second pressure may be lower than the first pressure. Different temperature and/or vacuum conditions can improve potency, clarity, and color.

A wiped film column may be utilized as the second stage to purify the extraction product. A wiped film column may include a motorized wiper, an internal or external condenser, and an outer jacket for heating or cooling. The motorized wipers rotate and create a thin film suited for highly efficient heat transfer. A condenser may be located in the middle of the wiped film column. This condenser may be cooled for condensing vapor in the wiped film column. The wiped film column produces a distillate and residue product. Typically, the distillate is the targeted product that was collected at a certain boiling point. The residue product may include a feed constituent that did not evaporate during distillation. A vacuum system may be utilized and allows distillation to occur at lower temperatures. The vacuum system may include one or more vacuum conditioners designed to condense terpenes and solvents that did not condense on the condenser. Residuals, waxes, fats, chlorophylls, and plant materials that did not boil are separated into the residue.

The first and second products include a target fraction, wherein a first potency of the target fraction in the first product may be more or less or equal to a second potency of the target fraction in the second product. The conditions of the firs and second stages being tuned to cause the first and second stages to be similar in potency. The first and second products include a target fraction, wherein a first potency of the target fraction in the first product may be equal to a second potency of the target fraction in the second product. In one example, purifying the first product to the second product occurs as a direct and contained transfer from the first to second stage in a solvent-free environment. In another example, the first product is a distillaate product and a residue product. Distillate product from one or more of the first stage and the second stage may be combined or otherwise transferred directly to downstream processes. For example, distillate from one or more stages may be transferred to a downstream chromatography system, a crystallization system, a chemical reactor, a holding tank, or a winterization system. In one example, residue is transferred to the second stage from the first stage. Due to this second stage, about 80% or more of a target product may be recovered from the residue. In one example, the target product may be a cannabinoid.

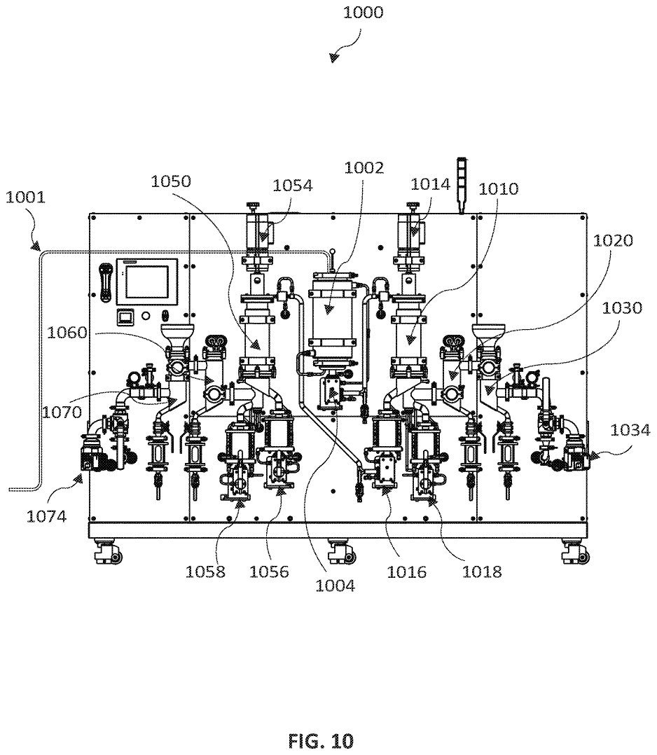

FIG. 10 illustrates a distillation system 1000 that may be utilized for method 900, according to some embodiments. Distillation system 1000 includes jacketed piping 1001, input reservoir 1002, input reservoir output pump 1004, first stage 1010, first motor 1014, first residue pump 1016, first distillate pump 1018, first vacuum condenser 1020, first cold finger 1030, first vacuum pump 1034, second stage 1050, second motor 1054, second residue pump 1056, second distillation pump 1058, second vacuum condenser 1060, second cold finger 1070, and second vacuum pump 1074. As shown in FIG. 10, the distillation system 1000 does not require a gas/solvent stripping stage prior to the first stage 1010 due to the stripping abilities of the upstream interface device of FIG. 8A. A gas/solvent stripping stage would include flash evaporating volatile components such as residual solvents and volatile extraction components by heating the volatile components under vacuum. Multiple distillation systems 1000 may be utilized in a continuous process. Any one of first residue pump 1016, first distillate pump 1018, second residue pump 1056, and second distillation pump 1058 may transfer product to downstream processes.

A conditioned extraction product, such as from the interface system of the present disclosure, enters the distillation system 1000 via input reservoir 1002. Input reservoir 1002 may include one or more level detection devices, such as bubble level sensor and a float. The conditioned extraction product is transferred by the input reservoir output pump 1004 from the input reservoir 1002 to the first stage 1010. First stage 1010 includes a wiped film column for separating two or more components into a distillate product and a residue product. The first residue pump 1016 may transfer the residue product to the second stage 1050 for further purification. In one example, the pressure of the first stage 1010 is different than the pressure of the second stage 1050 to increase purity of the products.

First stage 1010 includes the first motor 1014 for turning a wiper in the first stage 1010. In one example, the operating temperature of the first stage 1010 ranges from about 20° C. to about 300° C. In another example, the operating temperature of the first stage 1010 ranges from about 100° C. to about 250° C. In yet another example, the operating temperature of the first stage 1010 ranges from about 150° C. to about 200° C. First stage 1010 produces a distillate product and a residue product by forming a thin film with the first motor 1014 and evaporating one or more components. The first residue pump 1016 receives residue separated from the conditioned extraction product, while the first distillate pump 1018 receives distillate separated from the conditioned extraction product. The first residue pump 1016 transfers the residue product to the second stage 1050.

The first vacuum condenser 1020 and the first cold finger 1030 act as a vacuum conditioning system for the first vacuum pump 1034. The first vacuum condenser 1020 and the first cold finger 1030 may remove terpenes. In one example, the first vacuum pump 1034 includes a roughing pump. A rotary vane oil-less pump may be utilized, which is beneficial as this pump does not contaminate any product. In another example, the first vacuum pump 1034 includes a turbo vacuum pump. The first vacuum pump 1034 operates to decrease the pressure of the first stage 1010 below atmospheric pressure. In one example, the operating pressure of the first stage 1010 ranges from about 0.01 Torr to about 760 Torr. In another example, the operating pressure of the first stage 1010 ranges from about 0.01 Torr to about 0.1 Torr. In yet another example, the operating pressure of the first stage 1010 ranges from about 0.02 Torr to about 0.05 Torr.

The residue product enters the second stage 1050 and is separated into a distillate product and a residue product. In one example, the operating temperature of the second stage 1050 ranges from about 20° C. to about 300° C. In another example, the operating temperature of the second stage 1050 ranges from about 100° C. to about 250° C. In yet another example, the operating temperature of the second stage 1050 ranges from about 150° C. to about 200° C. Second stage 1050 produces a distillate product and a residue product by forming a thin film with the second motor 1054 and evaporating one or more components. The second residue pump 1056 receives residue separated from the residue product, while the second distillate pump 1058 receives distillate separated from the residue product.

The second vacuum condenser 1060 and the second cold finger 1070 act as a vacuum conditioning system for the second vacuum pump 1074. The second vacuum condenser 1060 and the second cold finger 1070 may remove terpenes. The second vacuum pump 1074 may include one or more of a turbo pump and a roughing pump. The second vacuum pump 1074 operates to decrease the pressure of the second stage 1050 below atmospheric pressure. In one example, the operating pressure of the second stage 1050 ranges from about 0.001 Torr to about 760 Torr. In another example, the operating pressure of the second stage 1050 ranges from about 0.001 Torr to about 0.1 Torr. In yet another example, the operating pressure of the second stage 1050 ranges from about 0.002 Torr to about 0.02 Torr.

Utilizing two separate zones of distillation is beneficial for controlling the vacuum of each stage. Within each column an interface exists between liquid and gas. The interface may be controlled by the vapor pressure of all the components evaporating. Therefore, in the second stage, the resistance to mass transfer is less than the first stage due to the difference in total vapor pressure. Since the vapor pressure is different in each zone, different vacuum conditions may be utilized. Therefore, the vacuum in the second stage may be lower and the temperature may be greater in the second stage.

The input reservoir 1002 may include one or more spray balls for a clean-in-place system. Since the distillation system 1000 is contained, the clean-in-place system allows for cleaning various portions of the distillation system 1000. For example, during a clean-in-place mode, a clean-in-place pump transfers fluid to the spray ball. The fluid enters the input reservoir 1002 and is transferred to the first stage 1010 and the second stage 1050. During this process, the first motor 1014 and the second motor 1054 may be pumping fluid sufficient to assist in the cleaning process. Valves may be closed to block the clean-in-place fluid from entering the vacuum conditioning system.

Importantly, the extraction product can be transferred directly to the first stage without a gas/solvent stripping stage. In this stage, volatile components such as residual solvents and volatile extraction components would be flash evaporated by heating under vacuum and contaminate the distillate purity. Typically, evaporation takes places first and several condensers are required to condense the volatile components to remove these components. This gas/solvent stripping stage adds additional cost and complexity to a process. Therefore, removing this step reduces overall cost, complexity, and time. Further, more than one stage is advantageous as the temperature and pressure at each stage can be tuned according to the target fractions at each stage. Including a separate vacuum system with each stage allows for fine tuning of the vacuum at each stage. It is advantageous to include different vacuum conditions at each stage as the vapor pressure of the target compound may be different at each stage.

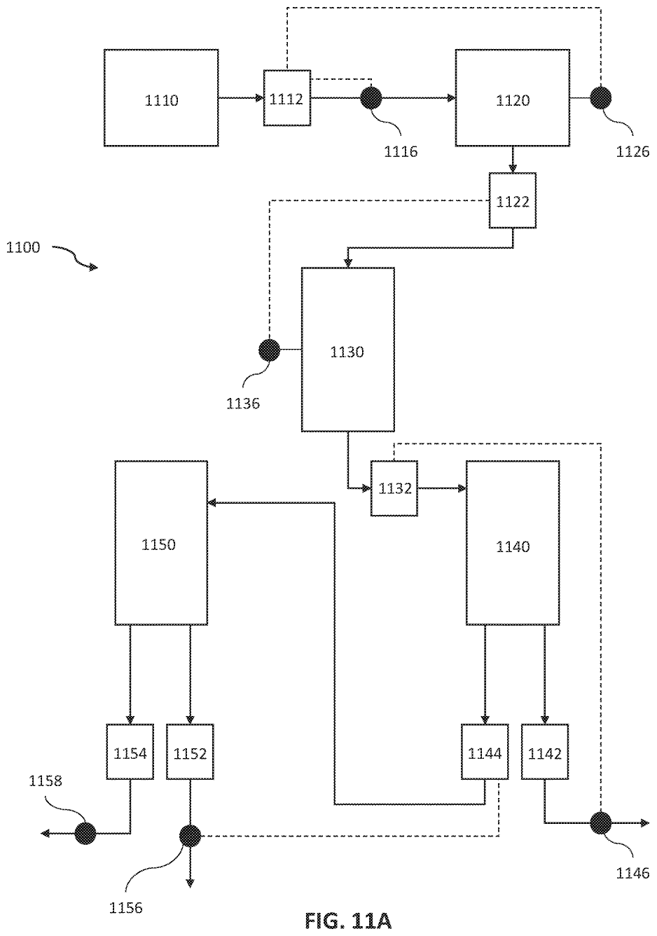

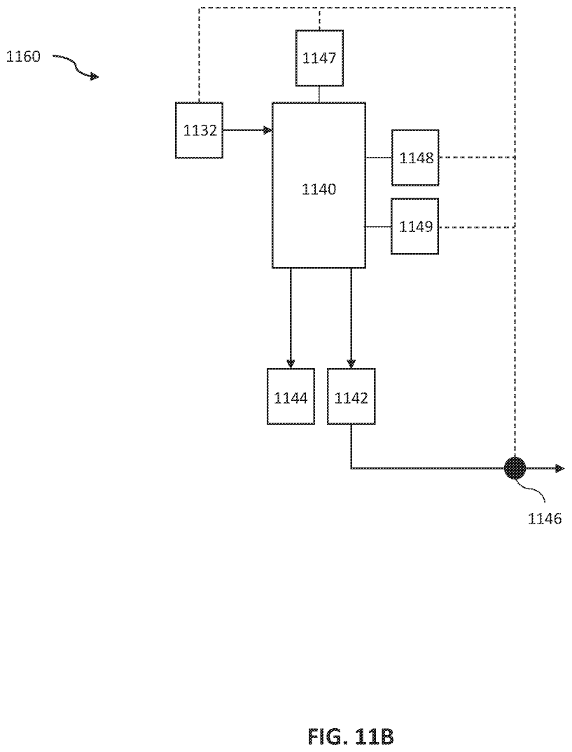

FIG. 11A illustrates an extraction to distillation control scheme 1100, according to some embodiments. FIG. 11 illustrates a possible flow direction from extraction to distillation products. Controlling the extraction to distillation process may include controlling the cannabinoid output concentrations from the first stage and the second stage. Controlling this output concentration is important as the input concentration may change. FIG. 11 illustrates extractor 1110, pump 1112, sensor 1116, interface system 1120, pump 1122, sensor 1126, distillation input reservoir 1130, pump 1132, sensor 1136, first stage 1140, distillate pump 1142, residue pump 1144, sensor 1146, second stage 1150, distillate pump 1152, residue pump 1154, sensor 1156, and sensor 1158. Dashed lines in FIG. 11 represent control signals. These dashed lines may include a control system for automating the extraction to distillation system. Portions of the extraction to distillation system may not be shown in FIG. 11 for ease of illustrating the control scheme.

The speed or revolutions per minute (RPM) of any one of the pumps included in the extraction to distillation system may be controlled by one or more sensors sufficient to maintain a desired pump output flow rate or target potency of the product. Pump 1112 may be controlled based on the measurements of sensor 1116 and/or sensor 1126. Pump 1112 may be used in conjunction with one or more valves to control the flow rate to downstream vessels. In one example, sensor 1116 is an inline flow rate sensor or temperature sensor in the piping connecting the extractor 1110 to the interface system 1120. In another example, sensor 1126 includes one or more of a thermocouple, level sensor, and differential pressure sensor system. For example, the output flow rate from the pump to the interface system 1120 may be controlled by a level sensor in the interface system 1120. Further, the sensor 1126 may include two pressure sensors at the top and at the bottom of the vessel sufficient to provide a differential pressure measurement in the interface system 1120 and thus a level indication. The flow rate to the interface system 1120 may be controlled by a valve without the use of a pump 1112. The valve may assist in controlling the pressure in the interface system 1120 (further discussed in subsequent figures). This valve may be controlled based on temperature at the inlet tube to the interface system 1120.

Pump 1122 may be controlled based on one or more measurements from sensor 1136. Pump 1122 may be used in conjunction with one or more valves to control the flow rate to downstream vessels. In one example, sensor 1136 includes a bubble sensor system, an example of which is discussed in subsequent paragraphs and figures. A novel bubble sensor system can accurately measure the level of conditioned products in the distillation input reservoir 1130. In another example, sensor 1136 includes one or more of a pressure sensor, temperature sensor, and level sensor.

Pump 1132 may be controlled based on one or more measurements from sensor 1146. Pump 1132 may be used in conjunction with one or more valves to control the flow rate to downstream vessels. Pump 1132 may be utilized to control the target % cannabinoid concentration the distillate product from the first stage 1140. In one example, sensor 1146 includes UV fluorescence, Raman spectroscopy, online HPLC (high-performance liquid chromatography), online NMR (nuclear magnetic resonance), or online near IR. In addition, or alternatively, sensor 1146 may include the use of soft sensors such as temperature and pressure that correspond to more selective sensors via a digital twin control mathematical model. Sensor 1146 is capable of detecting or accurately predicting the % cannabinoid in the distillate from the first stage 1140. Therefore, based on the % cannabinoid value from sensor 1146, the output flow rate from pump 1132 may be controlled sufficient to maintain the % cannabinoid concentration within a targeted range or control limits.

Residue pump 1144 may be controlled based on one or more measurements from sensor 1156. Sensor 1156 may be the same type of sensor as sensor 1146. Distillate pump 1142 may be used in conjunction with one or more valves to control the flow rate to downstream vessels. In one example, sensor 1156 includes UV fluorescence, Raman spectroscopy, online HPLC (high-performance liquid chromatography), or online NMR (nuclear magnetic resonance). In addition, or alternatively, sensor 1156 may include the use of digital twins control models. Sensor 1156 is capable of detecting the cannabinoid percentage in the distillate from the second stage 1150. Therefore, based on the cannabinoid percentage value from sensor 1156, the output flow rate from distillate pump 1144 may be controlled sufficiently to maintain the cannabinoid percentage concentration within a targeted range or control limits. Sensor 1158 may include any type of sensor discussed in the present disclosure. For example, sensor 1158 may be an analytical sensor or may be a flow rate sensor. Measurements from sensor 1158 may be utilized for controlling valves or pumps in extraction to distillation control scheme 1100.

In one example, the cannabinoid percentage transferred from distillate pump 1144 to second stage 1150 ranges from about 15% to about 25%. In another example, the cannabinoid percentage transferred from distillate pump 1144 to second stage 1150 is about 20%. In one example, the cannabinoid percentage in the distillate at sensor 1156 is maintained between about 75% and about 90%. For example, the cannabinoid percentage at sensor 1146 may be the same as the cannabinoid percentage at sensor 1156. Controlling temperatures and/or pressures in the first stage 1140 and the second stage 1150 may be sufficient to maintain an equal cannabinoid percentage in the distillate of the first stage 1140 and the distillate of the second stage 1150.

FIG. 11B illustrates a distillation control scheme 1160, according to some embodiments. Second stage 1150 and other portions of an example distillation system have been omitted for clarity. FIG. 11B includes pump 1132, first stage 1140, distillate pump 1142, residue pump 1144, sensor 1146, mixer 1147, evaporator temperature 1148, and vacuum 1149. Sensor 1146 may be utilized to control the evaporator temperature 1148 in the first stage 1140. Based on the cannabinoid percentage detected by sensor 1146, the temperature of the evaporator may be increased or decreased to maintain a desired cannabinoid percentage in the distillate. Additionally, or alternatively, sensor 1146 may be utilized to control the mixer 1147 speed in the first stage 1140. The mixer 1147 speed may be increased or decreased to maintain a desired cannabinoid percentage in the distillate.

Sensor 1146 may be utilized to control the vacuum 1149 in the first stage 1140. The vacuum 1149 may be increased or decreased to maintain a desired cannabinoid percentage in the distillate. Further, cannabinoid percentage values from sensor 1146 may be utilized with other variables (such as evaporator temperature 1148 and pump 1132 RPM) to fit data. Multilinear regression or principal components analysis or other machine learning algorithms commonly deployed in the art may be utilized to create a model that will act as a digital twin to the physical process. The model for example may include one or more selective (1146,1156) and non selective (1116, 1126) sensors as measured on-line outputs and input data. Algorithms using standard commercially available chemometric packages can be used to create a digital twin that will relate inputs to outputs, optimize inputs and outputs, and predict inputs and outputs. Other sensors not disclosed but are anticipated to be useful are mass flow sensors, density sensors, mass sensors, motor rotation frequency and mixing rotations per minute. In one embodiment, temperature, pressure, RPM, flow rate, and mass flow rate and ultrafast on-line HPLC are used to predict the concentration of cannabinoid in the distillate. In another embodiment, UV fluorescence is used to selectively measure the percent active of the outputs in real time. In another embodiment, sensor 1146 or 1156 or 1158 returns a value that is out of specification for the cannabinoid percentage, a diverter valve may be utilized to transfer the distillate back to interface system 1120 or the distillation input reservoir 1130. In one example, the cannabinoid percentage in the distillate at sensor 1146 is maintained between about 75% and about 90%. In another example, the cannabinoid percentage in the distillate at sensor 1146 is maintained between about 80% and about 86%. The cannabinoid percentage entering the first stage 1140 may range from about 45% to about 60%. Similar to sensor 1146, sensor 1156 in FIG. 11A may be utilized to control distillate pump 1144, control the evaporator temperature in second stage 1150, control the mixer speed in second stage 1150, and control the vacuum system for second stage 1150.

### Example 1

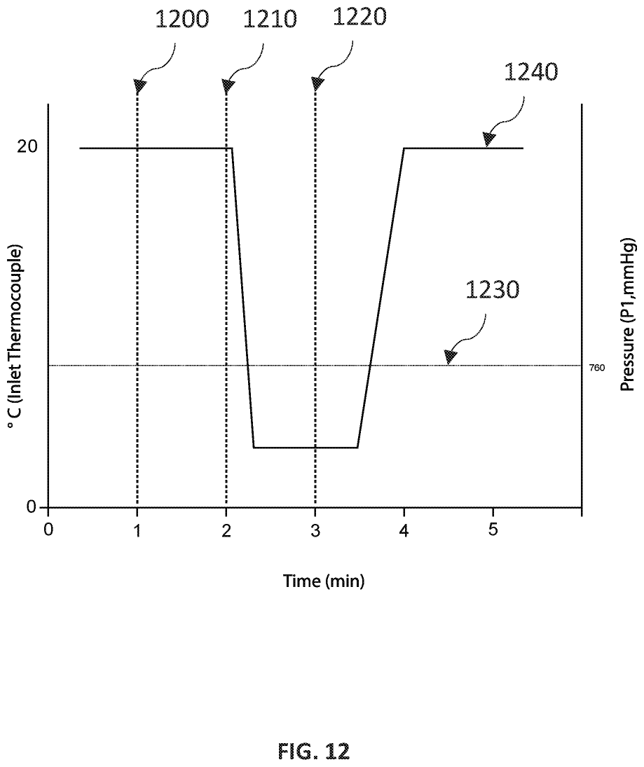

FIG. 12 illustrates an extraction to interface system control scheme output, according to some embodiments. This control scheme may be utilized to control the pressure in the interface system and may control the direct connection of high pressure extractor vessels to the interface system. In one example, the control scheme maintains the pressure in the interface system at or near atmospheric pressure 1230 and at room temperature 1200. The sharp decrease in temperature sensed by the thermocouple situated at the inlet valve immediately downstream of the inlet valve at time 1210, will trigger interface system to shut an inlet valve to the interface system at time 1220. The high pressure valve closes when the temperature at the inlet to the interface system has sharply decreased and the system eventually returns to normal temperature as shown at point 1240. The important aspect of the invention is that pressure 1230 does not significantly change during this process or at least does not increase to pressures above the working pressure limits of the interface vessel. The control principle uses the fact that if warm oil has stopped flowing to the interface vessel, cold carbon dioxide may still be transferred, and the thermocouple can sense the decrease in temperature and therefore the endpoint in extract product collection. One or more check valves may be utilized on the inlet to the interface system and the interface vessel to maintain proper operating pressures.

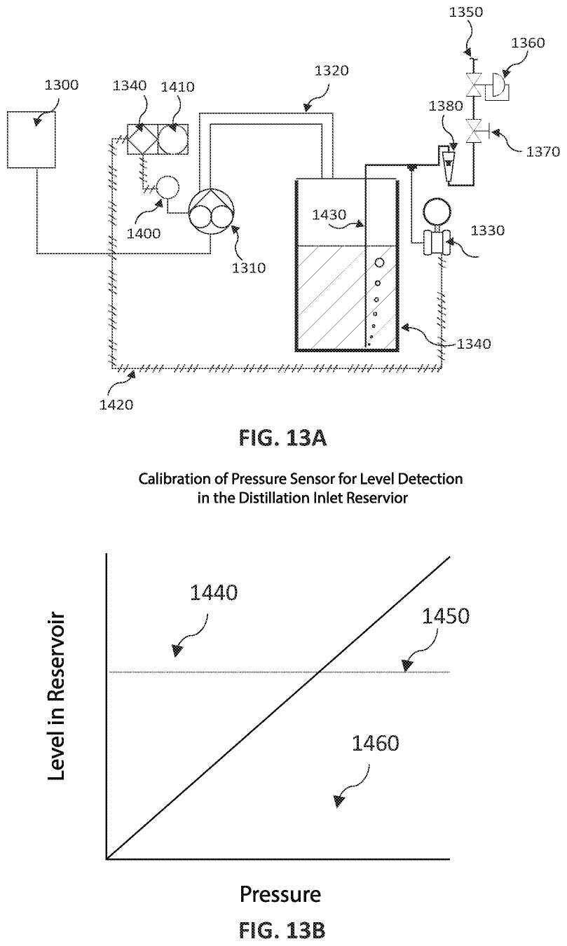

FIG. 13A illustrates a schematic of a bubble sensor system 1301 for distillation system 1000, according to some embodiments. The interface vessel 1300 is connected to the inlet pump 1310, which is subsequently connected to the input reservoir 1340. The tube 1320 connecting pump 1310 is jacketed to aid in cleaning. If this tube becomes cold, the extraction product that is being delivered to distillation system 1000 may solidify. It is critical that the material is maintained in a liquid state and therefore jacketed tube 1320 is a critical component to the overall use of the system. The bubble sensor system is sufficient to monitor the level of extraction product in the input reservoir 1340 and may assist in controlling the flow rate of extraction product to the input reservoir. The bubble sensor system includes a purge gas supply 1350, a pressure regulator 1360, a needle valve 1370, a rotameter 1380, a pressure sensor 1330, and a dip tube 1430. As the level of extraction product in the input reservoir 1340 increases, the pressure as measured by device 1330 increases. Inert gas is supplied from purge gas supply 1350 and is adjusted to a small flow rate via 1370 to create a steady stream of bubbles exiting from dip tube 1430. Bubbles are introduced to the bottom of the tube and pressure is measured with device 1330. Control signal wire 1420 conveys pressure information to a program logic control device 1340, which then subsequently controls the motor 1400 to start. The sensor may be calibrated by measuring the device 1301 output at various levels of liquid in Reservoir 1340. As previously discussed, the bubble sensor is easy to clean and is fouling resistant and has a distinct advantage over laser or other optical sensors that will foul in the presence of hot oil. Further, the bubble sensor provides highly accurate results for viscous fluids. The extraction product can be sticky and hot. Therefore, traditional level sensors such as floating balls, lasers, and optical light suffer from fouling, are inaccurate, and are not able to be cleaned. FIG. 13B illustrates the use of the level sensor output calibration curve 146 of the bubble sensor system for distillation system 1000, according to some embodiments. A control system compares the pressure reading to the max pressure 145 corresponding to the desired level of fluid inside the vessel. If the pressure is below the max pressure 145, the control system will turn on an interface vessel pump 1310. In one example, a bubble sensor is preferred over laser level systems as these laser systems foul over time.

### Example 2

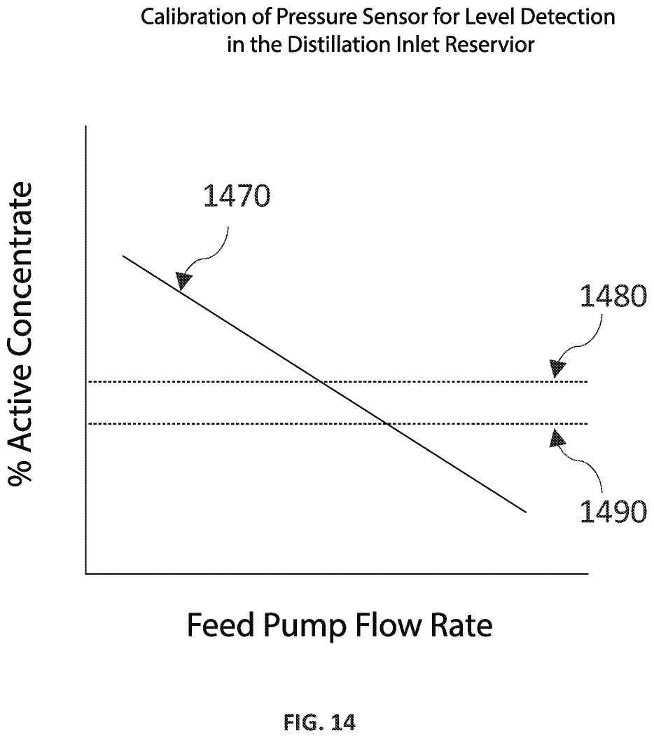

FIG. 14 illustrates a curve 146 comparing the feed pump 1132 flow rate to the active concentration % of distillate for the distillation system 1000, according to some embodiments. As the feed pump flow rate 1132 is increased, the active concentration % is decreased. Therefore, the feed pump flow rate from the interface system 1122 and/or input reservoir 1132 may be tuned to target a desired cannabinoid output % in the distillation system. Upper 147A and lower 147B control limits may be established to aid in continuous release of distillate product. Curve 146 will change slope, depending on the stage of distillation. The percent active measured This calibration/control system may be utilized to control the active concentration % output from the first stage using the inlet pump to the first stage and/or may be utilized to control the active concentration % from the second stage using the inlet pump to the second stage. The speed of the pump 1132 or 1144 may be increased or decreased to change the flow rate of the input material to the distillation column 1140 or 1150 respectively.

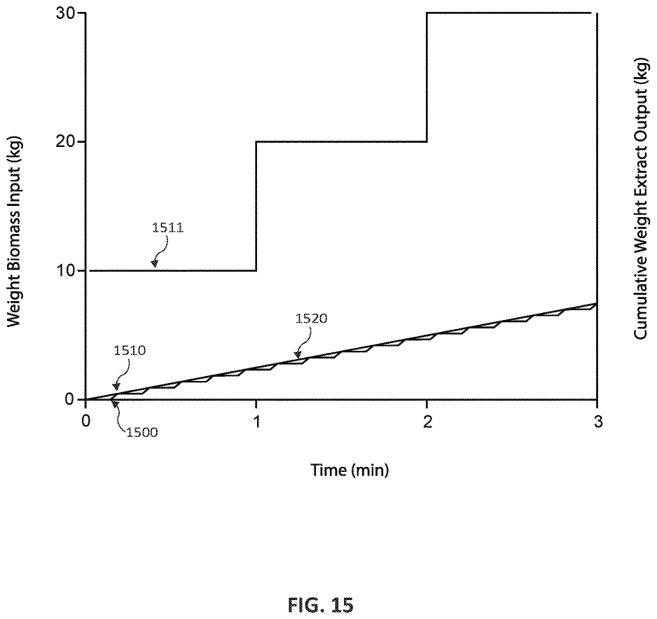

FIG. 15 illustrates a graph for managing the extraction inlet valve 805 actuation frequency based on the input of biomass to the extractor 1511 and the average outlet mass flow rate 1520 of the extractor, according to some embodiments. Based on the input weight of biomass and the extract output, the interface vessel pump mass flow rate (shown as feed flow rate in FIG. 15) to distillation may be set for a continuous process. For example, the feed flow rate for distillation may match output flow rate from the extraction system. The feed flow rate to distillation may be controlled by the interface vessel pump mass flow rate.

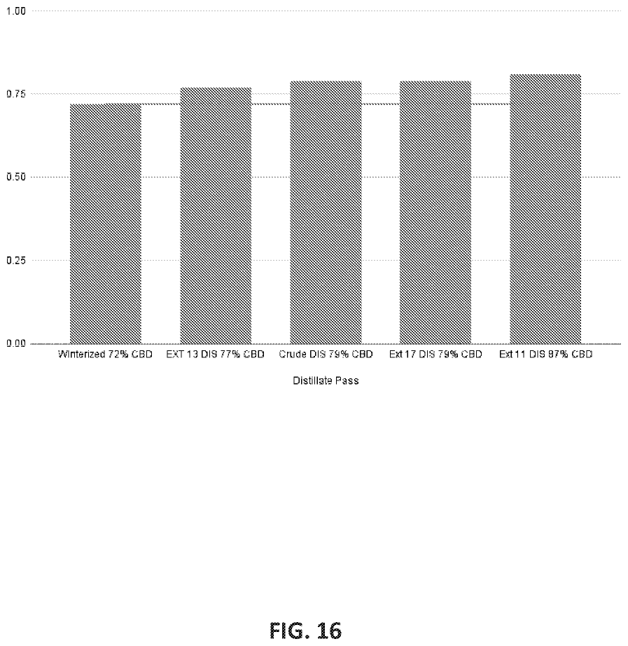

FIG. 16 illustrates a comparison of the potency of distillate output of FIG. 5A to a process that winterizes the extraction output using a traditional discontinuous method. The winterization method includes dissolving the extract output in 10 parts, food grade ethanol to one part extract by volume. The mixture is homogenized and is placed in a freezer at −20° C. After 24 hours the mixture is filtered and the waxes are washed by spraying cold Ethanol onto the filter cake and vacuum filtering. The ethanol is then removed from the extract and the potency is measured. The bar graph shows that the Winterized extract is 72% potent. The remaining bars on the graph show the output of a continuous system as depicted in FIG. 5A running under various temperature and pressure conditions for stage one and stage two. As can be seen, the potency is higher than Winterized extract. This distilled material was subsequently winterized, using the process described above. The Distillate Was shown to have approximately 1-2% waxes after winterization. The winterized extract was also re-winterized using the winterization method above. This double Winterized extract was shown to also contain 1 to 2% waxes. The reason for this wax being present in the Winterized extract, is that upon washing the waxes as described above, the wax gets re-dissolved into the extract even though the material was filtered at −20° C. The absence of washing the extract produced 4 to 5% lower recovery so it is concluded that washing all of the extract is necessary and that it will also re-dissolve some of the waxes that have been filtered.

### Example 3

Method 1 (conventional method) included extracting 100 kg of decarboxylated material. After extraction, the crude oil was winterized at −40° C. using ethanol. The oils and waxes were dissolved in the ethanol. After, the material was filtered with a 5 micron filter, and the ethanol was removed from the winterized oil to 500 ppm. The weight yield, potency, and cannabinoid yield, shown in Table 1 and Table 2, were measured after distillation of the winterized oil. Method 2 included extracting 100 kg of decarboxylated material. This extraction product was sent directly to the distillation unit and the weight yield, potency, and cannabinoid yield, shown in Table 1 and Table 3, were measured after distillation.

TABLE 1
Method 1 and 2 Potency and Cannabinoid Yield.

| | Method 1 | | Method 2 | |
|---|---|---|---|---|
| | (w/w % | Method 1 | (w/w % | Method 2 |
| | yield) | (kg) | yield) | (kg) |
| Weight Yield from | 10 | 10 | 10 | 10 |
| Extraction | | | | |
| Dewax/Winterization | 80 | 8.0 | — | — |
| Yield | | | | |
| Distillation Yield | 70 | 5.6 | 67 | 6.7 |

TABLE 2
Method 1 Potency and Cannabinoid Yield.

| | Potency | Cannabinoid | Cannabinoid Yield |
|---|---|---|---|
| Method 1 | (%) | (kg) | (%) |
| Cannabinoid Content | 65 | 6.5 | |
| (%) from Extraction | | | |
| Dewax/Winterization | 64 | 5.12 | 79 |
| Yield (%) | | | |
| Distillation Yield (%) | 72 | 4.03 | 62 |

TABLE 3
Method 2 Potency and Cannabinoid Yield.

| | Potency | Cannabinoid | Cannabinoid Yield |
|---|---|---|---|
| Method 2 | (%) | (kg) | (%) |
| Cannabinoid Content | 65 | 6.5 | |
| (%) from Extraction | | | |
| Distillation Yield (%) | 79 | 5.29 | 81 |

As shown in Table 1, method 2 (without winterization) increased the final distillation weight from 5.6 kg to 6.7 kg. Therefore, method 2 resulted in a 16% weight yield improvement. Each method started with 10 kg after extraction. As shown in Tables 2 and 3, method 2 (without winterization) increased the final cannabinoid yield percentage by 19%. Further, automation and this continuous process may yield about 15 w/w % or more total oil. In part, method 1 may have a decreased yield because of transfer losses. In batch processes, each step may account for about a 3% to 5% loss. Further, distillation is much more efficient compared to the filtration step in winterization. Method 1 can decrease operating costs by producing extracted oil without ethanol. Ethanol losses, ethanol hazardous waste disposal, ethanol reuse, storage costs, and quality control losses are all contributions to the total cost of using ethanol. Therefore, carbon dioxide provides cost savings and improved safety compared to ethanol.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

1. A method of converting a botanical-based biomass to an extract in a continuous process, the method comprising:
contacting the biomass with an extracting fluid to obtain an extraction product including an extracted oil;
conditioning the extraction product in an interface chamber by maintaining the extracted oil in a flowable condition and releasing one or more gasses through a unidirectional vent; and
transferring the conditioned extraction product directly to a purification system.

2. The method of claim 1, including contacting the biomass with the extracting fluid in an extraction chamber at an extraction temperature of below 60° C., wherein the extracting fluid is carbon dioxide.

3. The method of claim 1, including contacting the biomass with the extracting fluid in an extraction chamber at an extraction pressure ranging from 1000 psi to 5000 psi, wherein the extracting fluid is supercritical carbon dioxide.

4. The method of claim 1, wherein the one or more gasses include one or more of carbon dioxide, butane, and propane.

5. The method of claim 1, including conditioning the extraction product by passing a sweep fluid through the interface chamber to remove a condensable fluid from the interface chamber.

6. The method of claim 5, wherein the sweep fluid includes an inert gas.

7. The method of claim 5, wherein removing the condensable fluid includes directing the sweep fluid along a sweep path through the unidirectional vent sufficient to direct the condensable fluid to a condenser.

8. The method of claim 5, wherein the condensable fluid includes one or more of a water and volatile organic compounds.

9. The method of claim 5, including conditioning the extraction product by preventing oxidation of the extracted oil and by preventing condensation in the interface chamber.

10. The method of claim 1, including conditioning the extraction product without winterizing and filtering the extracted oil.

11. The method of claim 1, including conditioning the extraction product at a temperature between 40° C. and 150° C.

12. The method of claim 1, including conditioning the extraction product at a pressure below 10 psi.

13. The method of claim 1, including transferring the conditioned extraction product to the purification system in the absence of a condensable fluid and purifying the conditioned extraction product without otherwise processing the conditioned extraction product.

14. The method of claim 1, wherein the flowable condition includes a viscosity of less than 100 cP.

15. The method of claim 1, wherein the purification system purifies the conditioned extraction product by isolating a target fraction from the conditioned extraction product.

16. The method of claim 15, wherein purifying the conditioned extraction product includes at least one of distilling the conditioned extraction product into two or more components, crystallizing at least one component of the conditioned extraction product, and chromatographically separating the conditioned extraction product into two or more components.

17. The method of claim 15, wherein the target fraction includes one or more of a cannabinoid distillate, solid isolate, and liquid isolate.

18. The method of claim 1, further comprising controlling flow of extraction product based on a temperature of the interface chamber.

19. A method of converting a botanical-based biomass to an extract in a continuous process, the method comprising:
contacting the biomass with carbon dioxide at a pressure greater than 500 psi to obtain an extraction product including an extracted oil;
conditioning the extraction product in an interface chamber by maintaining the extracted oil in a flowable condition and releasing one or more gasses through a unidirectional vent;
transferring the conditioned extraction product directly to a winterization system; and
winterizing the conditioned extracted oil by contacting the conditioned extracted oil with ethanol,
wherein the interface chamber is maintained at a pressure of less than 100 psi.

20. The method of claim 19, further comprising contacting the botanical-based biomass with ethanol.

21.-60. (canceled)
